(19) United States
(12) Patent Application Publication
(10) Pub. No.: US 2026/0116248 A1
(43) Pub. Date: Apr. 30, 2026

(54) APPARATUS AND METHOD TO RECOMMEND CHARGING POINTS BASED ON PROBE DATA

(71) Applicant: HERE GLOBAL B.V., EINDHOVEN (NL)

(72) Inventors: JEROME BEAUREPAIRE, NANTES (FR); JEREMY MICHAEL YOUNG, BEVERLY HILLS, MI (US)

(73) Assignee: HERE GLOBAL B.V., EINDHOVEN (NL)

(21) Appl. No.: 18/929,642

(22) Filed: Oct. 29, 2024

(51) Int. Cl. B60L 53/68

(52) U.S. Cl. CPC B60L 53/68; B60L 2240/62; B60L 2240/68; B60L 2240/72; B60L 2260/46

(57) ABSTRACT

An apparatus to recommend charging points based on probe data is provided. The apparatus retrieves a first location associated with a first vehicle of a set of vehicles. The apparatus further determines a set of charging points within a first distance of the first vehicle based on the retrieved first location. The apparatus further retrieves, from one or more sources, a set of features comprising at least one of: a first feature, a second feature, and a third feature. At least one feature of the set of features is obtained from probe data associated with the set of vehicles. Further, the apparatus generates one or more recommendations associated with one or more charging points of the set of charging points based on the retrieved set of features. The apparatus further provides, via a user interface, the generated one or more recommendations as an option for selection by a user.

### TECHNOLOGICAL FIELD

The present disclosure generally relates to electric vehicle charging points, and more particularly relates to apparatus and method to recommend charging points based on probe data.

### BACKGROUND

Electric vehicles (EVs) have been gaining popularity in recent years as a sustainable and eco-friendly alternative to traditional gasoline-powered vehicles. With the growing concern about climate change and air pollution, EVs have become a vital component in the quest for a cleaner and healthier environment. Electric vehicle charging points (EVCPs), also known as Electric Vehicle (EV) charging stations or EV charging points, are increasingly growing in number as the adoption of EVs continues to grow.

As more people switch to EVs, the demand for convenient and easily accessible charging points is also increasing. However, finding convenient electric vehicle charging points is a big challenge for many EV owners. While the number of public charging points is growing rapidly, they still exist multiple challenges such as accessibility issues, working issues, location issues, and the like.

However, traditional methods for determining suitable EVCPs does not focuses on using convenience and comfort as factors due to which the problems described above may arise. Therefore, there is a need for a system for determining and recommending suitable electric vehicle charging points based on convenience and comfort.

### BRIEF SUMMARY OF SOME EXAMPLE EMBODIMENTS

In order to solve the foregoing problem, the present disclosure may provide an apparatus, a method and a computer program product to to recommend charging points based on probe data.

In one aspect, an apparatus to recommend charging points based on probe data is disclosed. The apparatus may include at least one processor and at least one non-transitory memory including computer program code instructions which may be configured to, when executed, cause the apparatus to retrieve a first location associated with a first vehicle of a set of vehicles. The computer program code instructions may be configured to, when executed, cause the apparatus to determine a set of charging points within a first distance of the first vehicle based on the retrieved first location. The computer program code instructions may be further configured to, when executed, cause the apparatus to retrieve, from one or more sources, a set of features including at least one of a first feature associated with one or more points of interest within a second distance of a corresponding charging point of the set of charging points, a second feature associated with an average duration of time spent by the set of vehicles at the corresponding charging point, and a third feature associated with destination information of the set of vehicles based on the corresponding charging point. At least one feature of the set of features may be obtained from probe data associated with the set of vehicles. The computer program code instructions may further be configured to, when executed, cause the apparatus to generate one or more recommendations associated with one or more charging points of the set of charging points based on the retrieved set of features and provide the generated one or more recommendations as an option for selection by a user via a user interface.

In additional apparatus embodiments, the computer program code instructions may further be configured to, when executed, cause the apparatus to apply a machine learning model on the retrieved set of features. The machine learning model may be a pre-trained model. The computer program code instructions may further be configured to, when executed, cause the apparatus to generate the one or more recommendations associated with the one or more charging points of the set of charging points based on the application of the machine learning model on the retrieved set of features.

In additional apparatus embodiments, the computer program code instructions may further be configured to, when executed, cause the apparatus to receive a first user input associated with the selection of a first recommendation of the one or more recommendations. The first recommendation may be associated with a first charging point of the set of charging points. The computer program code instructions may further be configured to, when executed, cause the apparatus to provide, via the user interface, navigation information associated with navigation from the first location to the first charging point based on the received first user input.

In additional apparatus embodiments, the computer program code instructions may further be configured to, when executed, cause the apparatus to receive a first user input associated with the selection of a first recommendation of the one or more recommendations. The first recommendation may be associated with a first charging point of the set of charging points. The computer program code instructions may further be configured to, when executed, cause the apparatus to provide, via the user interface, navigation information associated with navigation from the first location to the first charging point based on the received first user input.

In additional apparatus embodiments, the computer program code instructions may further be configured to, when executed, cause the apparatus to update, using the one or more sources, the establishment information associated with each of the one or more points of interests within the second distance of the corresponding charging point and determine a modification in the establishment information associated with at least one of the one or more points of interest based on the updated establishment information. The computer program code instructions may further be configured to, when executed, cause the apparatus to modify the one or more recommendations associated with the one or more charging points of the set of charging points based on the determined modification and provide, via the user interface, the modified one or more recommendations.

In additional apparatus embodiments, the computer program code instructions may further be configured to, when executed, cause the apparatus to determine, using the probe data, the average duration of time spent by the set of vehicles at first charging point of the set of charging points and compare the determined average duration of time spent by the set of vehicles with a pre-determined threshold. The computer program code instructions may further be configured to, when executed, cause the apparatus to update charging point information associated with the first charging point of the set of charging points based on the comparison. The one or more recommendations may be generated based on the charging point information. The computer program code instructions may further be configured to, when executed, cause the apparatus to store the updated charging point information in the one or more sources.

In additional apparatus embodiments, the computer program code instructions may further be configured to, when executed, cause the apparatus to calculate, using the probe data, a duration of time spent by each vehicle of the set of vehicles based on arrival time information and departure time information of the set of vehicles at the corresponding charging point of the set of charging points and determine the average duration of time spent by the set of vehicles associated with the corresponding charging point based on the calculated duration of time spent by each vehicle of the set of vehicles.

In additional apparatus embodiments, the computer program code instructions may further be configured to, when executed, cause the apparatus to retrieve, using one or more sources, a fourth feature indicative of parking information associated with each charging point of the set of charging points and retrieve, using one or more sources, a fifth feature associated with a functional class of a road segment associated with each charging point of the set of charging points. The computer program code instructions may further be configured to, when executed, cause the apparatus to update charging point information associated with each charging point of the set of charging points based on at least one of the fourth feature or the fifth feature. The one or more recommendations may be generated based on the charging point information. The computer program code instructions may further be configured to, when executed, cause the apparatus to store the updated charging point information in the one or more sources.

In additional apparatus embodiments, the computer program code instructions may further be configured to, when executed, cause the apparatus to obtain, from an electronic device associated with the user, second location information indicative of a location of the user of the first vehicle at a charging point of the set of charging points. The second location information may be obtained for a first time period. The computer program code instructions may further be configured to, when executed, cause the apparatus to determine mobility information associated with a mobility of the user during the first time period based on the obtained second location and update charging point information associated with the corresponding charging point based on the determined mobility information. The one or more recommendations may be generated based on the charging point information. The computer program code instructions may further be configured to, when executed, cause the apparatus to store the updated charging point information in the one or more sources.

In additional apparatus embodiments, the computer program code instructions may further be configured to, when executed, cause the apparatus to determine, using one or more sources, a sixth feature associated with accessibility information for each charging point of the set of charging points and update charging point information associated with the corresponding charging point of the set of charging points based on the determined sixth feature. The one or more recommendations may be generated based on the charging point information. The computer program code instructions may further be configured to, when executed, cause the apparatus to store the updated charging point information in the one or more sources.

In additional apparatus embodiments, the computer program code instructions may further be configured to, when executed, cause the apparatus to retrieve a second location associated with the first vehicle of the set of vehicles and determine the set of charging points within the first distance of the first vehicle based on the retrieved second location. The computer program code instructions may further be configured to, when executed, cause the apparatus to retrieve, from the one or more sources, the set of features associated with each charging point of the set of charging points and generate a first recommendation associated with a first charging point of the set of charging points based on the retrieved set of features and the updated charging point information associated with each charging point of the one or more charging points. The computer program code instructions may further be configured to, when executed, cause the apparatus to provide, via the user interface, the generated first recommendation.

In another aspect, a method for recommending charging points based on probe data is provided. The method may include retrieving a first location associated with a first vehicle of a set of vehicles and determining a set of charging points within a first distance of the first vehicle based on the retrieved first location. The method may further include retrieving, from one or more sources, a set of features including at least one of a first feature associated with one or more points of interest within a second distance of a corresponding charging point of the set of charging points, and a second feature associated with accessibility information for each charging point of the set of charging points. At least one feature of the set of features may be obtained from probe data associated with the set of vehicles. The method further may include generating one or more recommendations associated with one or more charging points of the set of charging points based on the retrieved set of features and providing, via a user interface, the generated one or more recommendations as an option for selection by a user.

In additional method embodiments, the method may further include applying a machine learning model on the retrieved set of features. The machine learning model is a pre-trained model. The method may further include generating the one or more recommendations associated with the one or more charging points of the set of charging points based on the application of the machine learning model on the retrieved set of features.

In additional method embodiments, the method may further include receiving a first user input associated with the selection of a first recommendation of the one or more recommendations. The first recommendation is associated with a first charging point of the set of charging points. The method may further include rendering, on the user interface, navigation information associated with navigation from the first location to the first charging point based on the received first user input.

In additional method embodiments, the method may further include retrieving, from the one or more sources, establishment information associated with each of the one or more points of interest. The establishment information is indicative of a type of establishment associated with a corresponding point of interest of the one or more points of interest. The method may further include generating the one or more recommendations associated with one or more charging points of the set of charging points based on the retrieved establishment information.

In additional method embodiments, the method may further include updating, using the one or more sources, the establishment information associated with each of the one or more points of interests within the second distance of the corresponding charging point and determining a modification in the establishment information associated with at least one of the one or more points of interest based on the updated establishment information. The method may further include modifying the one or more recommendations associated with the one or more charging points of the set of charging points based on the determined modification and providing, via the user interface, the modified one or more recommendations.

In additional method embodiments, the method may further include retrieving, using one or more sources, a third feature associated with an average duration of time spent by the set of vehicles at the corresponding charging point and updating charging point information associated with the corresponding charging point based on the retrieved third feature. The one or more recommendations may be generated based on the charging point information. The method may further include storing the updated charging point information in the one or more sources.

In additional method embodiments, the method may further include obtaining, from an electronic device associated with the user, second location information indicative of a location of the user of the first vehicle at a charging point of the set of charging points. The second location information is obtained for a first time period. The method may further include determining mobility information associated with a mobility of the user during the first time period based on the obtained second location and updating charging point information associated with the corresponding charging point based on the determined mobility information. The one or more recommendations may be generated based on the charging point information. The method may further include storing the updated charging point information in the one or more sources.

In yet another aspect, a computer program product comprising at least one non-transitory computer-readable storage medium having computer-executable program code portions stored therein, the computer-executable program code portions comprising program code instructions configured to receive a first user input for providing the one or more recommendations associated with one or more charging points for charging a first vehicle of a set of vehicles. The computer-executable program code portions further include program code instructions configured to retrieve a first location associated with a first vehicle of a set of vehicles. The computer-executable program code portions further include program code instructions configured to determine a set of charging points within a first distance of the first vehicle based on the retrieved first location. The computer-executable program code portions further includes program code instructions configured to retrieve, from one or more sources, a set of features including at least one of a first feature associated with one or more points of interest within a second distance of a corresponding charging point of the set of charging points, a second feature associated with an average duration of time spent by the set of vehicles at the corresponding charging point, and a third feature associated with destination information of the set of vehicles based on the corresponding charging point. At least one feature of the set of features may be obtained from probe data associated with the set of vehicles. The computer-executable program code portions further include program code instructions configured to generate one or more recommendations associated with one or more charging points of the set of charging points based on the retrieved set of features and provide the generated one or more recommendations as an option for selection by a user via a user interface.

In additional computer program product embodiments, the computer-executable program code portions further include program code instructions configured to receive, from the user, a second input associated with the selection of a first recommendation of the one or more recommendations. The first recommendation may be associated with a first charging point of the set of charging points. The computer-executable program code portions further include program code instructions configured to provide, via the user interface, navigation information associated with navigation from the first location to the first charging point based on the received second user input.

The disclosed apparatus may tend to solve the problem associated with the location and environment of Electric Vehicle Charging Points (EVCPs). While the placement of these charging points may seem optimal on paper, the reality of physical location of the EVCP may present several challenges for EV users. In one scenario, some of these charging points may not located in parking lots. Such absence of the parking lots may cause inconvenience for the EV users. Ideally, EVCPs should be situated in areas where vehicles can be parked for extended periods, allowing for the vehicle to be charged while the EV user carries out other activities. However, when these charging points are not in the parking lots, the EV users may face difficulties in leaving their vehicles unattended during the charging process.

In other scenario, the proximity of EVCPs to certain Point of Interests (POIs) may also pose problems. For example, if a charging point is linked to a POI that may not be suitable for long-term parking or staying alone for extended periods, it may prevent the EV users from utilizing these charging points. The safety and security of both the vehicle and the EV user can be a concern in such scenarios.

In conclusion, while the expansion of EVCPs is crucial for the growth of electric vehicles, careful consideration must be given to their placement. Ensuring that these charging points are in safe, convenient locations is vital to encourage more people to adopt the electric vehicles. This problem calls for a comprehensive solution that considers the practical realities of EV charging, going beyond what might seem feasible on paper.

The disclosed apparatus may use probe data to determine relevant information associated with the EVCPs (one or more charging points). Based on the determined information, the apparatus may provide recommendations associated with the EVCPs that are suitable for charging the vehicle. The disclosed apparatus may result in providing better recommendations to the EV users, improving user experience by not recommending EVCPs that may be unsuitable for charging the vehicle, and the apparatus may utilize feedback from the EV users (such as crowdsourcing) to eliminate unsuitable EVCPs from getting recommended.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 is a diagram that illustrates a network environment to recommend charging points based on probe data, in accordance with an embodiment of the disclosure;

FIG. 2 illustrates a block diagram of the apparatus of FIG. 1, in accordance with an embodiment of the disclosure;

FIG. 3A is a block diagram that illustrates a block diagram depicting training the machine learning model on the retrieved set of features, in accordance with an embodiment of the disclosure;

FIG. 3B is a diagram that illustrates a block diagram that shows operations for determination of average time duration of the set of vehicles at the set of charging points based on the probe data, in accordance with an embodiment of the disclosure;

FIG. 3C is a diagram that illustrates a block diagram depicting operations associated with determination of second location information from an electronic device associated with the user, in accordance with an embodiment of the present disclosure;

FIG. 4 is a block diagram that illustrates a block diagram depicting operations associated with the retrieval of set of features using one or more sources and applying the machine learning model on the retrieved set of features to generate one or more recommendations associated with the one or more charging points, in accordance with an embodiment of the disclosure;

FIG. 5 illustrates a flowchart that depicts rendering of one or more recommendations based on a change in the set of features associated with the set of charging points, in accordance with an embodiment of the disclosure;

FIG. 6A depicts an exemplary scenario for rendering one or more recommendations on the user interface of the first vehicle, in accordance with an embodiment of the disclosure;

FIG. 6B depicts an exemplary scenario for rendering navigational instructions from the first location to the location of the selected recommendation via the user interface associated with the first vehicle, in accordance with an embodiment of the disclosure;

FIG. 7 is a flowchart that illustrates an exemplary first method for recommending charging points based on probe data, in accordance with an embodiment of the disclosure;

FIG. 8 is a flowchart that illustrates an exemplary second method for recommending charging points based on probe data, in accordance with an embodiment of the disclosure; and

FIG. 9 is a flowchart that illustrates an exemplary third method for recommending charging points based on probe data, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatus and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received, and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect.

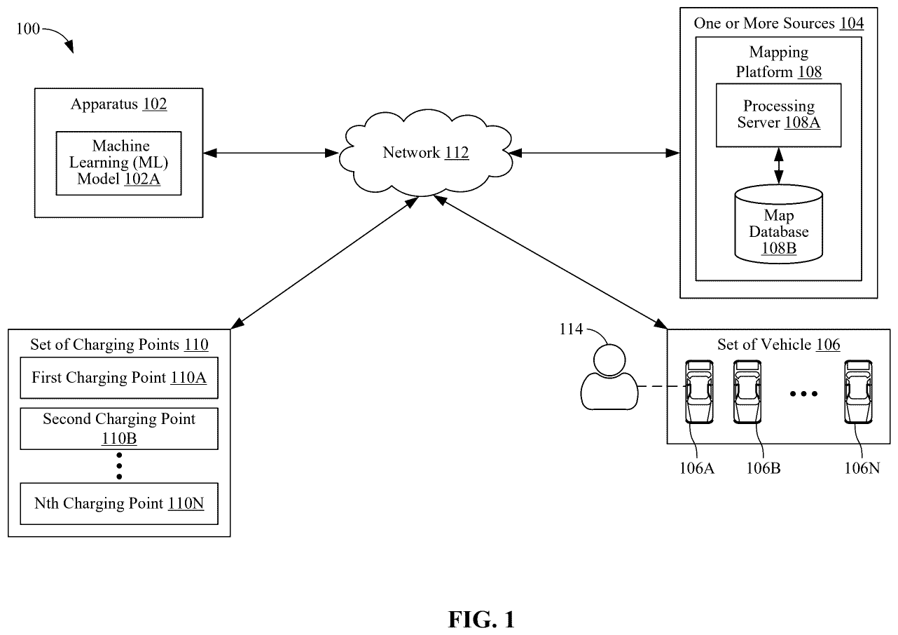

FIG. 1 is a diagram that illustrates a network environment to recommend charging points based on probe data, in accordance with an embodiment of the disclosure. With reference to FIG. 1, there is shown a diagram of a network environment 100. The network environment 100 includes an apparatus 102, a one or more sources 104, a set of vehicles 106, and a set of charging points 110. The set of vehicles 106 may include a first vehicle 106A, a second vehicle 106B, up to an Nth first vehicle 106N. The set of charging points 110 may include a first charging point 110A, a second charging point 110B up to an Nth charging point 110N. The one or more sources 104 may include a mapping platform 108. The mapping platform 108 may further include a processing server 108A and a map database 108B. The network environment 100 may further include a network 112. In an embodiment, the apparatus 102 may include the machine learning model 102A. In an embodiment, the apparatus 102 may be associated with at least the first vehicle 106A of the set of vehicles 106. In another embodiment, the apparatus 102 may be integrated within each vehicle of the set of vehicles 106.

The apparatus 102 may include suitable logic, circuitry, interfaces, and/or code that may be configured to recommend charging points based on probe data. In an embodiment, the apparatus 102 may be configured to retrieve a first location associated with the first vehicle 106A of the set of vehicles 106. The apparatus 102 may further determine the set of charging points 110 within a first distance of the first vehicle 106A based on the retrieved first location. The apparatus 102 may further retrieve, from one or more sources 104, a set of features including at least one of a first feature associated with one or more points of interest within a second distance of a corresponding charging point of the set of charging points 110, a second feature associated with an average duration of time spent by the set of vehicles 106 at the corresponding charging point, and a third feature associated with destination information of the set of vehicles 106 from the corresponding charging point. In an embodiment, at least one feature of the set of features may be obtained from probe data associated with the set of vehicles 106.

Further, the apparatus 102 may be configured to generate one or more recommendations associated with one or more charging points of the set of charging points 110 based on the retrieved set of features. The apparatus 102 may be further configured to provide, via a user interface, the generated one or more recommendations as an option for selection by the user 114. Examples of the apparatus 102 may include, but are not limited to, an electronic control unit (ECU), an electronic control module (ECM), a computing device, a mainframe machine, a server, a computer workstation, any and/or any other device.

In an embodiment, the apparatus 102 may include the machine learning model 102A. The machine learning model 102A may correspond to a neural network-based regression model. The neural network may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of all nodes in the input layer may be coupled to at least one node of the hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result.

In an exemplary embodiment, the apparatus 102 may be onboard the first vehicle 106A. For example, the apparatus 102 may be an electric vehicle charging point recommendation system installed in the first vehicle 106A for determining the deviation associated with the usage of the first vehicle 106A or the vehicle driving behavior and further recommending one or more charging points. In another example embodiment, the apparatus 102 may be the processing server 108A of the mapping platform 108 and therefore may be co-located with or within the mapping platform 108.

In another embodiment, the apparatus 102 may be embodied as a cloud-based service, a cloud-based application, a cloud-based platform, a remote server-based service, a remote server-based application, a remote server-based platform, or a virtual computing system. In yet another example embodiment, the apparatus 102 may be an OEM (Original Equipment Manufacturer) cloud. The OEM cloud may be configured to anonymize any data received by the apparatus 102, such as from the user profile data, before using the data for further processing, such as before sending the data to the map database 108B. For example, anonymization of the data may be done by the mapping platform 108.

In an embodiment, each of the set of vehicles 106 such as, the first vehicle 106A may be a non-autonomous vehicle, a semi-autonomous vehicle, or a fully autonomous vehicle, for example, as defined by National Highway Traffic Safety Administration (NHTSA). Examples of the first vehicle 106A may include, but are not limited to, a two-wheeler electric vehicle, a three-wheeler electric vehicle, a four-wheeler electric vehicle, or more than a four-wheeler electric vehicle. Examples of two-wheeler vehicles may include, but are not limited to, an electric two-wheeler, or a hybrid two-wheeler. Similarly, examples of the four-wheeler vehicle may include, but are not limited to, an electric car, or a hybrid car. It may be noted here that the four-wheeler diagram of the set of vehicles 106 is merely shown as examples in FIG. 1. The present disclosure may also be applicable to other structures, designs, or shapes of the first vehicle 106A. The description of other types of vehicles and respective structures, designs, or shapes has been omitted from the disclosure for the sake of brevity.

In some example embodiments, the first vehicle 106A may include processing means such as a central processing unit (CPU), storage means such as on-board read-only memory (ROM), and random access memory (RAM), acoustic sensors such as a microphone array, position sensors such as a global positioning system (GPS) sensor, gyroscope, a light detection and ranging (LiDAR) sensor, a proximity sensor, motion sensors such as an accelerometer, an image sensor such as a camera, a display enabled user interface such as a touch screen display, and other components as may be required for specific functionalities of the first vehicle 106A. In some example embodiments, one or more user equipment may be associated, coupled, or otherwise integrated with the first vehicles 106A, such as an advanced driver assistance system (ADAS), a personal navigation device (PND), a portable navigation device, and/or other devices that may be configured to provide route guidance and navigation-related functions to the user 114.

The mapping platform 108 may include suitable logic, circuitry, and interfaces that may be configured to store one or more map attributes and sensor data associated with traffic on link segments and lane segments. The mapping platform 108 may be configured to store and update map data indicating the traffic data along with other map attributes, road attributes, and traffic entities, in the map database 108B. The mapping platform 108 may include techniques related to, but not limited to, geocoding, routing (multimodal, intermodal, and unimodal), clustering algorithms, machine learning in location-based solutions, natural language processing algorithms, and artificial intelligence algorithms. Data for different modules of the mapping platform 108 may be collected using a plurality of technologies including, but not limited to drones, sensors, connected cars, cameras, probes, and chipsets. In some embodiments, the mapping platform 108 may be embodied as a chip or chip set. In other words, the mapping platform 108 may include one or more physical packages (such as chips) that include materials, components, and/or wires on a structural assembly (such as a baseboard).

In some example embodiments, the mapping platform 108 may include the processing server 108A for carrying out the processing functions associated with the mapping platform 108 and the map database 108B for storing map data. In an embodiment, the processing server 108A may include one or more processors configured to process requests received from the apparatus 102. The processors may fetch sensor data and/or map data from the map database 108B and transmit the same to the apparatus 102 in a format suitable for use by the apparatus 102.

Continuing further, the map database 108B may include suitable logic, circuitry, and interfaces that may be configured to store the sensor data and map data, which may be collected from the each of the set of vehicles 106 traveling on the road. In accordance with an embodiment, such sensor data may be updated in real-time or near real-time such as within a few seconds, a few minutes, or on an hourly basis, to provide accurate and up-to-date sensor data. The sensor data may be collected from any sensor that may inform the mapping platform 108 or the map database 108B of features within an environment that is appropriate for traffic-related services. In accordance with an embodiment, the sensor data may be collected from any sensor that may inform the mapping platform 108 or the map database 108B of features within an environment that is appropriate for mapping. For example, motion sensors, inertia sensors, image capture sensors, proximity sensors, Light Detection and Ranging (LiDAR) sensors, and ultrasonic sensors may be used to collect the sensor data. The gathering of copious quantities of crowd-sourced data may facilitate the accurate modeling and mapping of an environment, whether it is a road link or a link within a structure, such as in an interior of a multi-level parking structure.

The map database 108B may further be configured to store the traffic-related data and road topology and geometry-related data for a road network as map data. The map data may also include cartographic data, routing data, and maneuvering data. The map data may also include, but is not limited to, locations of intersections, diversions to be caused due to accidents, congestions or constructions, suggested roads, or links to avoid, and an estimated time of arrival (ETA) depending on different links. In accordance with an embodiment, the map database 108B may be configured to receive the map data including the road topology and geometry-related attributes related to the road network from external systems, such as one or more background batch data services, streaming data services, and third-party service providers, via the network 112.

In accordance with an embodiment, the map data stored in the map database 108B may further include data about changes in traffic situations registered by GPS provider(s), such as, but not limited to, incidents, road repairs, heavy rains, snow, fog, time of day, day of a week, holiday or other events which may influence the traffic condition of a link segment.

In some embodiments, the map database 108B may further store historical probe data for events (such as, but not limited to, traffic incidents, construction activities, scheduled events, and unscheduled events) associated with Point of Interest (POI) data records or other records of the map database 108B.

For example, the data stored in the map database 108B may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as an electronic device. The navigation-related functions may correspond to vehicle navigation, pedestrian navigation, navigation to a favored parking spot, or other types of navigation. While example embodiments described herein generally relate to vehicular travel, example embodiments may be implemented for bicycle travel along bike paths, boat travel along maritime navigational routes, etc. The compilation to produce the end-user databases may be performed by a party or entity separate from the map developer. For example, a customer of the map developer, such as a navigation device developer or other end user device developer, may perform compilation on the received map database 108B in a delivery format to produce one or more compiled navigation databases.

In some embodiments, the map database 108B may be a master geographic database configured on the side of the apparatus 102. In accordance with an embodiment, a client-side map database 108B may represent a compiled navigation database that may be used in or with end-user devices to provide navigation instructions based on the traffic data, the traffic conditions, speed adjustment, ETAs, and/or map-related functions to navigate through the intersection connected links on the route.

In some embodiments, the map data may be collected by end-user vehicles (such as the first vehicle 106A) which use vehicles on-board one or more sensors to detect data about various entities such as road objects, lane markings, links, and the like. These vehicles are also referred to as probe vehicles and form an alternate form of data source for map data collection, along with ground truth data. Additionally, data collection mechanisms like remote sensing, such as aerial or satellite photography may be used to collect the map data for the map database 108B.

For example, the map database 108B may include lane and intersection data records or other data that may represent links in the route, pedestrian lane, or areas in addition to or instead of the vehicle lanes. The lanes and intersections may be associated with attributes, such as geographic coordinates, street names, lane identifiers, lane segment identifiers, lane traffic direction, address ranges, speed limits, turn restrictions at intersections, and other navigation-related attributes, as well as POIs, such as fueling stations, hotels, restaurants, museums, stadiums, offices, auto repair shops, buildings, stores, and parks. The map database 108B may additionally include data about places, such as cities, towns, or other communities, and other geographic features such as, but not limited to, bodies of water, and mountain ranges.

In some example embodiments, images received from image sources may be stored within the map database 108B of the mapping platform 108. In certain cases, the mapping platform 108, using the processing server 108A, may suitably process the received images. For example, such processing may include, suitably labeling the images based on corresponding associated lane and/or link, point of interest within the link and/or lane, and other information relating to the respective link and/or lane. Such labeled images may then be stored within the map database 108B as map data.

In an embodiment, the set of charging points 110 may include the first charging point 110A, the second charging point 110B, up to the Nth charging point 110N. Each charging point of the set of charging points 110 may be an infrastructure system designed to recharge electric vehicles (such as, the first vehicle 106A). Such charging points may be of distinct types and power levels, catering to different charging needs. Each charging point of the set of charging points 110 may be, for example, but not limited to, a Level 1 charging point, a Level 2 charging point, and a Level 3 (Direct Current (DC) fast charging) charging point.

The network 112 may be wired, wireless, or any combination of wired and wireless communication networks, such as cellular, Wi-Fi, internet, local area networks, or the like. In some embodiments, the network 112 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. Long Term Evaluation - Advanced Pro (LTE-Advanced Pro)), 5G New Radio networks, International Telecommunication Union (ITU)-International Mobile Communication (IMT) 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In operation, the apparatus 102 may be configured to retrieve the first location associated with the first vehicle 106A of the set of vehicles 106. In an exemplary embodiment, the first location associated with the first vehicle 106A may be indicative of a real-time location of the first vehicle 106A at a time when a recommendation process for the one or more charging points of the set of charging points 110 may be initiated. In an exemplary embodiment, the process to recommend one or more charging points of the set of charging points 110 may be initiated by the user 114 of the first vehicle 106A. In another exemplary embodiment, the process to recommend one or more charging points of the set of charging points 110 may be initiated automatically based on a current charge level (or a battery charge level) of a battery associated with the first vehicle 106A being low than a battery charge level threshold.

Further, the apparatus 102 may be configured to determine the set of charging points 110 within the first distance of the first vehicle 106A based on the retrieved first location. In an exemplary embodiment, the first distance may be determined based on the current charge level (or the battery charge level) of the battery associated with the first vehicle 106A and distance that may be travelled by the first vehicle 106A with the current charge level of the first vehicle 106A. In an embodiment, the battery charge level threshold may be a pre-defined minimum battery charge level value below which the first vehicle 106A may be able to travel up to a pre-defined distance (say 20 miles). For example, if the battery charge level threshold may be 20% and the current charge level of the first vehicle 106A at the first location is 20%, then the apparatus 102 may determine the distance from the first location that the first vehicle 106A may cover with the current charge level. Further, if the determined distance may be, for example, 20 miles, then the apparatus 102 may be configured to determine the set of charging points within 20 miles of the first vehicle 106A based on the retrieved first location of the first vehicle 106A.

In an embodiment, the apparatus 102 may be configured to retrieve the set of features associated with the determined set of charging points 110 from one or more sources 104. The one or more sources 104 may be, for example, but not limited to, the map database 108B, data from an electric vehicle charging point service provider, and/or crowdsourcing data. Further, the set of features may include the first feature associated with the one or more points of interest of the set of charging points 110. In an exemplary embodiment, the points of interest within the second distance (say 100 meters) of a charging point may refer to a location or an area of interest that may be close to the corresponding charging point. The points of interest associated with the corresponding charging point may include, but not limited to, a grocery store, a shopping mall, a liquor store, an adult entertainment zone, and a smoking zone.

Further, the set of features associated with each of the set of charging points 110 may include the second feature associated with the average duration of time spent by the set of vehicles 106 at the corresponding charging point while historically charging the corresponding vehicle at the corresponding charging point. The apparatus 102 may determine the average duration of time spent by the set of vehicles 106 at the corresponding charging point. The average duration of time may indicate the average amount of time spent by the set of vehicles 106 at the corresponding charging point during historical charging events. In an exemplary embodiment, based on the average duration of time, the apparatus 102 may classify the corresponding charging point as at least one of a suitable charging point or an unsuitable charging point. For example, if the average duration of time spent by the set of vehicles 106 at the first charging point 110A may be greater than the pre-determined threshold, then the first charging point 110A may be classified as suitable charging point. Further, if the average duration of time spent by the set of vehicles 106 at the first charging point 110A may be less than the pre-determined threshold, then the first charging point 110A may be classified as unsuitable charging point.

In an embodiment, the set of features associated with each of the set of charging points 110 may include the third feature associated with destination information of the set of vehicles 106 from the corresponding charging point. For example, if the first vehicle 106A travels from the first charging point 110A to a second location, then the information about the second location may correspond to the destination information. In an embodiment, the second location may be for example, but not limited to, a home of the user, the second charging point 110B, a police station, and a fire station. In an embodiment, the apparatus 102 may be configured to classify the one or more charging points based on the destination information of the set of vehicles 106. For example, if the user 114 of the first vehicle 106A may drive from the first charging point 110A to the second location (for example, the second charging point 110B, the police station, and the fire station), then the first charging point 110A may be classified as unsuitable charging point. Further, if the user 114 of the first vehicle 106A may drive from the first charging point 110A to the second location (for example, the home of the user 114) then the first charging point 110A may be classified as the suitable charging point.

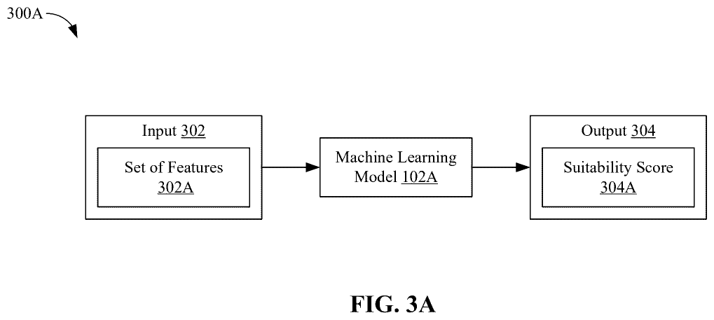

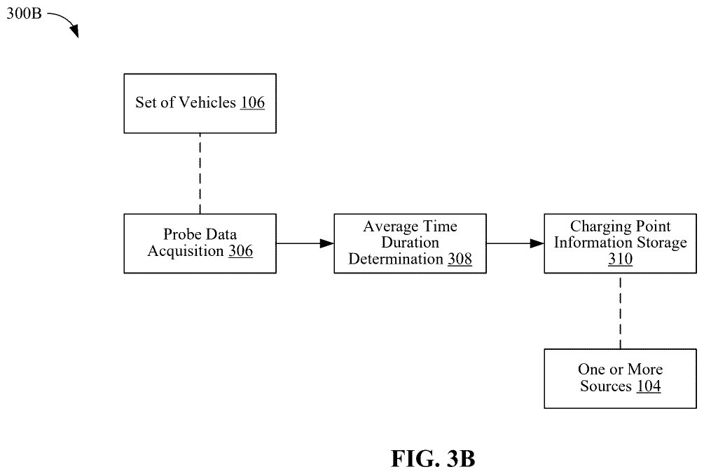

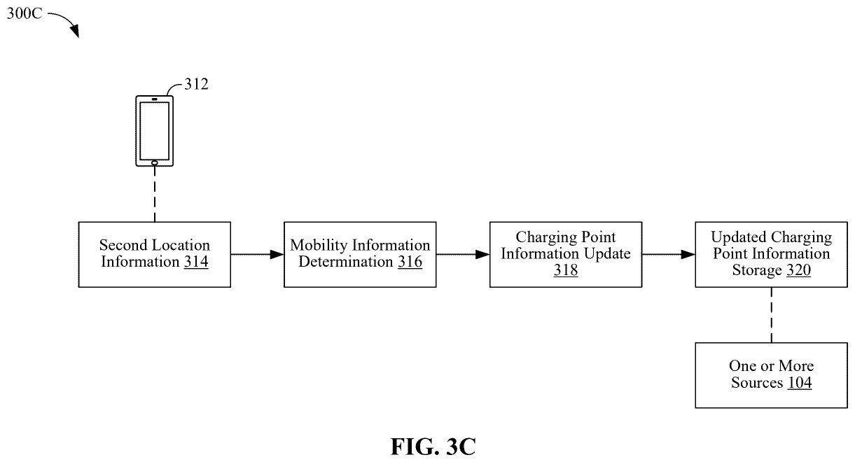

In an embodiment, the set of features associated with each of the set of charging points 110 may further include at least a fourth feature indicative of parking information associated with each charging point of the set of charging points 110, a fifth feature associated with a functional class of a road segment associated with each charging point of the set of charging points 110, and a sixth feature associated with accessibility information for each charging point of the set of charging points 110. Further details about the fourth feature, the fifth feature and the sixth feature are provided, for example, in FIG. 3.

In an embodiment, the apparatus 102 may be configured to utilize the machine learning model 102A to classify each of the set of charging point 110 as one of the suitable charging point or the unsuitable charging point. For example, the retrieved set of features from the one or more sources 104 may be provided as input to the machine learning model 102A. In an exemplary embodiment, the machine learning model 102A may be trained on the data provided as input, where the input may be associated with the historical charging events. The trained machine learning model 102A may be utilized to classify each of the set of charging points 110 as the suitable charging point or the unsuitable charging point. Further, the apparatus 102 may use the classification made by the machine learning model 102A to recommend one or more charging points in real-time.

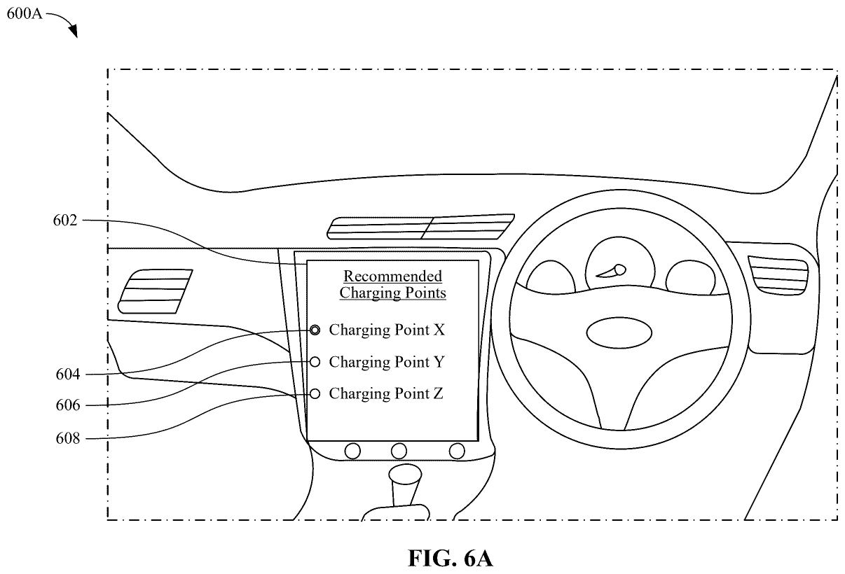

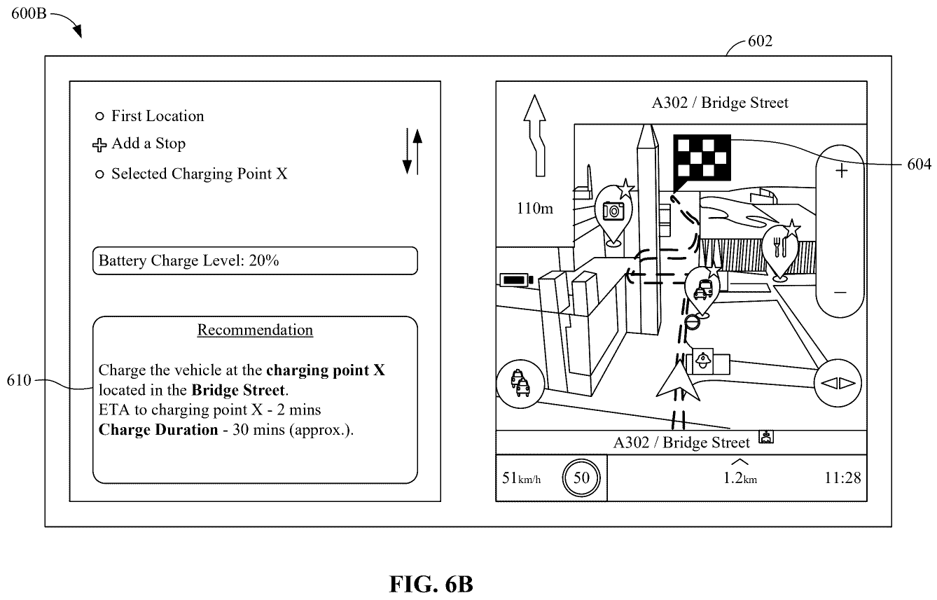

Further, the apparatus 102 may be configured to generate one or more recommendations associated with one or more charging points of the set of charging points 110 based on a combination of the retrieved set of features as discussed above. The apparatus 102 may be further configured to provide, via a user interface, the generated one or more recommendations as an option for selection by the user 114 as shown in FIGS. 6A and 6B.

The apparatus 102 may be communicatively coupled to each of the set of vehicles 106 (such as the first vehicle 106A), and the mapping platform 108, via the network 112. In an embodiment, the apparatus 102 may be communicatively coupled to other components not shown in FIG. 1 via the network 112. All the components in the network environment 100 may be coupled directly or indirectly to the network 112. The components described in the network environment 100 may be further broken down into more than one component and/or combined together in any suitable arrangement. Further, one or more components may be rearranged, changed, added, and/or removed.

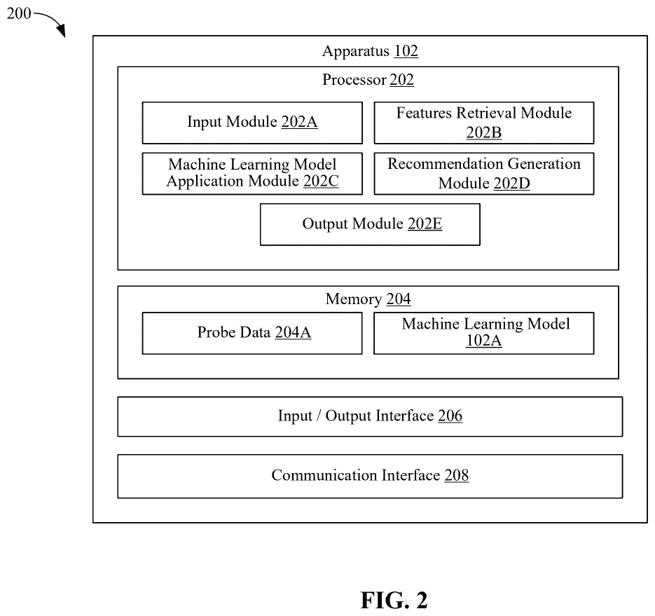

FIG. 2 illustrates a block diagram 200 of the apparatus of FIG. 1, in accordance with an embodiment of the disclosure. FIG. 2 is explained in conjunction with FIG. 1. In FIG. 2, there is shown the block diagram 200 of the apparatus 102. The apparatus 102 may include at least one processor 202 (referred to as a processor 202, hereinafter), at least one non-transitory memory 204 (referred to as a memory 204, hereinafter), an input/output (I/O) interface 206, and a communication interface 208. The processor 202 may include modules, depicted as, an input module 202A, a features retrieval module 202B, a machine learning model application module 202C, a recommendation generation module 202D and an output module 202E. The processor 202 may be connected to the memory 204, the I/O interface 206 and the communication interface 208 through wired or wireless connections. Although in FIG. 2, it is shown that the apparatus 102 includes the processor 202, the memory 204, the I/O interface 206, and the communication interface 208 however, the disclosure may not be so limiting and the apparatus 102 may include fewer or more components to perform the same or other functions of the apparatus 102. In an embodiment, the input module 202A, and the output module 202E may be integrated within the I/O interface 206. In some embodiments, the input module 202A may receive input data (such as user inputs) and the output module 202E may output processed data using the I/O interface 206.

The processor 202 of the apparatus 102 may be configured to execute the computer program code instructions which may be configured to cause the apparatus 102 to retrieve the first location associated with the first vehicle 106A, determine the set of charging points 110, retrieve the set of features, generate the one or more recommendations, and provide the one or more recommendations via the user interface for selection by the user 114. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the apparatus 102.

In an example, when the processor 202 may be embodied as an executor of computer program code instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the communication interface 208 of the apparatus 102. The communication interface 208 may provide an interface for accessing various features and data stored in the apparatus 102.

In some embodiments, the processor 202 may be configured to provide Internet-of-Things (IoT) related capabilities to users of the apparatus 102 disclosed herein. The IoT-related capabilities may in turn be used to provide smart city solutions by providing charging point recommendation, real-time safety distance between vehicles, real-time warnings, big data analysis, and sensor-based data collection by using the cloud-based mapping apparatus for providing accurate navigation instructions and ensuring driver safety. The I/O interface 206 may provide the user interface for communication of the apparatus 102 with the user 114.

In one embodiment, the input module 202A of the processor 202 may be configured to execute the computer program code instructions which may be configured to cause the apparatus 102 to retrieve the first location associated with the first vehicle 106A of the set of vehicles 106. The first location may correspond to the current real-time location of the first vehicle 106A. In an example, the first location of the first vehicle 106A may be obtained from Global Navigation Satellite System (GNSS) or GPS systems installed on the first vehicle 106A.

In another embodiment, the input module 202A of the processor 202 may be further configured to execute the computer program code instructions which may be configured to cause the apparatus 102 to receive an input from the user 114. The input may be associated with the initiation of recommendation for the one or more charging points of the set of charging points 110 within the first distance of the first vehicle 106A. In an embodiment, the user 114 may provide the input via an infotainment system associated with the first vehicle 106A, a user device associated with the user 114, or via a voice command received by a microphone associated with the first vehicle 106A or the user device. In another embodiment, the input module 202A may receive an automated request for recommendation of one or more charging points. The automated request may be triggered once the current charge level of the first vehicle 106A that may be monitored by the apparatus 102, may be one of equal to, or less than the battery charge level threshold.

Furthermore, in another embodiment, the input module 202A of the processor 202 may further be configured to execute the computer program code instructions which may be configured to cause the apparatus 102 to receive the first user input associated with the selection of a first recommendation of the one or more recommendations. The first recommendation may be associated with the first charging point 110A of the set of charging points 110. In an example, the user 114 may select the first recommendation associated with the first charging point 110A from the one or more recommendations of the set of charging points 110, via the user interface and the first user input is received by the input module 202A.

In an embodiment, the processor 202 may further include the features retrieval module 202B. The features retrieval module 202B may be configured to retrieve, from the one or more sources 104, the set of features associated with the set of charging points 110. The set of features may include at least one of the first feature associated with one or more points of interest within the second distance of the corresponding charging point of the set of charging points 110, the second feature associated with the average duration of time spent by the set of vehicles 106 at the corresponding charging point, and the third feature associated with destination information of the set of vehicles 106 from the corresponding charging point. Each of the one or more points of interest may correspond to specific locations of interest or significance to the user 114 associated with the first vehicle 106A. The points of interest may encompass a wide range of places such as, but not limited to, historical landmarks, natural wonders, cultural attractions, recreational sites, commercial hubs, the liquor store, the adult entertainment zone, the grocery store and the like.

In another embodiment, the features retrieval module 202B of the processor 202 may be further configured to execute the computer program code instructions which may be configured to cause the apparatus 102 to retrieve, from the one or more sources 104, establishment information associated with each of the one or more points of interest. The establishment information may be indicative of the type of establishment associated with the corresponding point of interest of the one or more points of interest associated with the set of charging points 110.

In another embodiment, the features retrieval module 202B of the processor 202 may further be configured to execute the computer program code instructions which may be configured to cause the apparatus 102 to retrieve, using the one or more sources 104, the fourth feature indicative of the parking information associated with each charging point of the set of charging points 110. Furthermore, the features retrieval module 202B of the processor 202 may further be configured to execute the computer program code instructions which may be configured to cause the apparatus 102 to retrieve, using the one or more sources 104, the fifth feature associated with the functional class of the road segment associated with each charging point of the set of charging points 110.

In another embodiment, the features retrieval module 202B of the processor 202 may further be configured to execute the computer program code instructions which may be configured to cause the apparatus 102 to obtain, from the electronic device associated with the user 114, the second location information indicative of a location of the user 114 of the first vehicle 106A at the charging point of the set of charging points 110. In an example, the electronic device may include a smartphone being operated by the user 114 which may indicate the location of the user 114 and may be used to determine the distance of the user 114 from the first charging point 110A during the charging duration. For example, if the user 114 may be sitting in the first vehicle 106A entirely during the charging duration, this may indicate that the first charging point 110A may be unsafe for the user 114 or there may be no shopping malls/gaming zones/resting zones/parks near the first charging point 110A.

The machine learning model application module 202C of the processor 202 may be configured to execute the computer program code instructions which may be configured to cause the apparatus 102 to apply the machine learning model 102A on the retrieved set of features. The machine learning model 102A may be a pre-trained model. The retrieved set of features may include at least one of the first feature associated with one or more points of interest within the second distance of the corresponding charging point of the set of charging points 110, the second feature associated with the average duration of time spent by the set of vehicles 106 at the corresponding charging point, and the third feature associated with destination information of the set of vehicles 106 from the corresponding charging point.

Further, the retrieved set of features may include at least the fourth feature indicative of the parking information associated with each charging point of the set of charging points 110, the fifth feature associated with the functional class of the road segment associated with each charging point of the set of charging points 110, and the sixth feature associated with accessibility information for each charging point of the set of charging points 110. In an embodiment, the machine learning model application module 202C may cause the apparatus 102 to apply the trained machine learning model 102A for the recommendation of one or more charging points for charging the set of vehicles 106 in real-time.

The recommendation generation module 202D of the processor 202 may be configured to execute the computer program code instructions which may be configured to cause the apparatus 102 to generate the one or more recommendations associated with the one or more charging points of the set of charging points 110 based on the retrieved set of features. In an embodiment, the recommendation generation module 202D of the processor 202 may be configured to execute the computer program code instructions which may be configured to cause the apparatus 102 to generate the one or more recommendations associated with the one or more charging points of the set of charging points 110 based on the application of the machine learning model 102A on the retrieved set of features. In an example, the machine learning model 102A may classify each charging point of the set of charging points 110 as one of the suitable charging point or the unsuitable charging point for the charging of the first vehicle 106A and the one or more recommendations may be associated with only the charging points that may be classified as the suitable charging point by the apparatus 102 by utilizing the machine learning model 102A.

The output module 202E may be configured to execute the computer program code instructions which may be configured to cause the apparatus 102 to provide, using the user interface, the generated one or more recommendations as the option for selection by the user 114. In an example, the output module 202E may output the generated one or more recommendations on the user interface of the infotainment system associated with the first vehicle 106A. In an embodiment, the output module 202E may be configured to execute the computer program code instructions which may be configured to cause the apparatus 102 to provide, via the user interface, the navigation information associated with the navigation from the first location to the first charging point 110A based on the received first user input. The first user input may be received by apparatus 102 from the user 114 associated with the first vehicle 106A through the input module 202A. In an embodiment, the output module 202E may output the generated navigation information on the user interface. In an example, the navigation information may include a best route based on distance and traffic information, for the first vehicle 106A to reach the first charging point 110A from the first location.

The memory 204 of the apparatus 102 may be configured to store the machine learning model 102A and the probe data 204A. The memory 204 may be non-transitory and may include, for example, one or more volatile and/or non-volatile memories. In other words, for example, the memory 204 may be an electronic storage device (for example, a computer readable storage medium) including gates configured to store data (for example, bits) that may be retrievable by a machine (for example, a computing device like the processor 202). The memory 204 may be configured to store information, data, content, applications, instructions, or the like, for enabling the apparatus 102 to carry out various functions in accordance with an example embodiment of the present disclosure.

For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein.

In some example embodiments, the I/O interface 206 may communicate with the apparatus 102 and display the input and/or output of the apparatus 102. As such, the I/O interface 206 (for example, the infotainment system) may include a display screen and, in some embodiments, may also include a keyboard, a mouse, a joystick, a touch screen, touch areas, soft keys, one or more microphones, a plurality of speakers, or other input/output mechanisms. In one embodiment, the apparatus 102 may include a user interface circuitry configured to control at least some functions of one or more I/O interface elements such as a display device and, in some embodiments, a plurality of speakers, a ringer, one or more microphones and/or the like. The processor 202 and/or I/O interface 206 circuitry including the processor 202 may be configured to control one or more functions of one or more I/O interface 206 elements through computer program instructions (for example, software and/or firmware) stored on the memory 204 accessible to the processor 202. The processor 202 may further render the one or more recommendations associated with one or more charging points of the set of charging points 110 based on the retrieved set of features via the user interface or the I/O interface.

The communication interface 208 may include an input interface and output interface for supporting communications to and from the apparatus 102 or any other component with which the apparatus 102 may communicate. The communication interface 208 may be any means such as a device or circuitry embodied in either hardware or a combination of hardware and software that is configured to receive and/or transmit data to/from a communications device in communication with the apparatus 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms. In some embodiments, the communication interface 208 may enable communication with a cloud-based network to enable deep learning, such as using the machine learning model 102A (that may be hosted on the cloud-based network).

FIG. 3A is a block diagram 300A that illustrates a block diagram depicting training the machine learning model 102A on the retrieved set of features 302A, in accordance with an embodiment of the disclosure. FIG. 3 is explained in conjunction with elements from FIG. 1 and FIG. 2. The operations may start at 302.

In an embodiment, the apparatus 102 may retrieve the set of features 302A from the one or more sources 104. The set of features 302A may be associated with each charging point of the set of charging points 110. In an embodiment, the set of features 302A may be obtained using the probe data 204A associated with the set of vehicles 106. In an embodiment, the apparatus 102 may receive the probe data 204A associated with the set of vehicles 106 for a historical time period. The historical time period may be for example, but not limited to, 1 month, 2 months, 1 year, and the like.

In an embodiment, the set of features 302A may include the first feature. The first feature may be associated with the one or more points of interest within the second distance of the corresponding charging point of the set of charging points 110. For example, the points of interest may include, but not limited to, a liquor store, a grocery store, an adult entertainment zone, or a smoking zone that may be undesirable for the user 114. The second distance may be a pre-determined distance. In an embodiment, the second distance may be pre-determined by the user 114. In another embodiment the pre-determined second distance may be stored in the memory 204 of the apparatus 102. For example, the second distance may be 100 meters.

Further, the apparatus 102 may be configured to retrieve, from the one or more sources 104, establishment information associated with each of the one or more points of interest. Further, the establishment information may be indicative of the type of establishment associated with the corresponding point of interest of the one or more points of interest. For example, if the retrieved establishment information associated with the corresponding point of interest of the first charging point 110A may indicate one of the liquor store, the adult entertainment zone, the smoking zone, then the users associated with the set of vehicles 106 may not prefer travelling to the corresponding charging point for charging their vehicles. In an alternate example, if the retrieved establishment information associated with the corresponding point of interest of the first charging point 110A may indicate one of a grocery store, a children play ground, a shopping mall, a movie theater, then the users associated with the set of vehicles 106 may prefer travelling to the corresponding charging point for charging their vehicles.

In an embodiment, the set of features 302A may further include the second feature. The second feature may be associated with the average duration of time spent by the set of vehicles 106 at the corresponding charging point. The apparatus 102 may determine, using the probe data 204A associated with the set of vehicles 106, the average duration of time of the set of vehicles 106 at the corresponding charging point. The probe data 204A may be associated with the set of vehicles 106 that may be charged at the corresponding charging point during historical charging events. The average duration of time may indicate the average amount of time spent by the set of vehicles 106 at the corresponding charging point. The apparatus 102 may compare the average duration of time spent by the set of vehicles 106 at the corresponding charging point with the pre-determined threshold.

For example, the first vehicle 106A arrived at the first charging point 110A at a first timestamp. The first timestamp may be, for example, 15:30:00. The arrival time information associated with the first vehicle 106A may include the first timestamp when the first vehicle 106A may have arrived at the first charging point 110A during a historical charging event. Further, the first vehicle 106A may depart from the first charging point 110A at a second timestamp. The second timestamp may be, for example, 16:00:00. The departure time information associated with the first vehicle 106A may include the second timestamp when the first vehicle 106A may have departed from the first charging point 110A during the historical charging event. The apparatus 102 may be configured to calculate the duration of time spent by the first vehicle 106A at the first charging point 110A based on the arrival time information and the departure time information. The duration of time may be, for example, 30 minutes. Similarly, the apparatus 102 may calculate the duration of time for each of the set of vehicles 106 at the first charging point 110A of the set of charging points 110.

Further, based on the calculated duration of time spent by each vehicle of the set of vehicles 106 at the first charging point 110A, the apparatus 102 may determine the average duration of time spent by the set of vehicles 106 associated with the first charging point 110A based on the calculated duration of time. In an exemplary embodiment, if the duration of time spent by the first vehicle 106A at the first charging point 110A may be for example, 30 minutes, the duration of time spent by the second vehicle 106B at the first charging point 110A may be for example, 20 minutes, and the duration of time spent by the third vehicle at the first charging point 110A may be for example, 40 minutes, then the apparatus 102 may determine the average duration of time spent by the set of vehicles 106 (say the first vehicle 106A, the second vehicle 106B, and the third vehicle) at the first charging point 110A. The determined average duration of time at the first charging point 110A may be, for example, 30 minutes (as (Total Time/Total count of vehicles) is (90 minutes/3=30 minutes). Further, the apparatus 102 may be configured to store the average duration of time spent by the set of vehicles 106 at the first charging point 110A in the one or more sources 104. Similarly, the apparatus 102 may determine, using the probe data 204A associated with the set of vehicles 106, the average duration of time spent by the set of vehicles 106 at each charging point of the set of charging points 110.

In an embodiment, the set of features 302A may further include the third feature. The third feature may be associated with the destination information of the set of vehicles 106 from the corresponding charging point. In an embodiment, the apparatus 102 may determine the destination information using the probe data 204A associated with the set of vehicles 106. The destination information may represent location the set of vehicles 106 may travel to, from the corresponding charging point.

In an exemplary embodiment, if the first vehicle 106A travelled to the location from the first charging point 110A after the historical charging event. The location may correspond to one of the police stations, or the hospital, then this may be indicative of some unwanted situation (such as a fight event, a ransacking event, and the like) that may have occurred during the charging duration of the first vehicle 106A at the first charging point 110A. In another exemplary embodiment, if the first vehicle 106A travelled to the location from the first charging point 110A at the historical charging event and where the location corresponds to one of the second charging point 110B, then this may indicate that the user 114 of the first vehicle 106A faced some issues during charging duration of the first vehicle 106A at the first charging point 110A and had to travel to the second charging point 110B to charge the first vehicle 106A. Such issues that may be faced by the user 114 may be, for example, but not limited to, technical issues associated with the first charging point 110A (such as, charger not working), or non-technical issues associated with the first charging point 110A (such as, user 114 may not have felt safe at the first charging point 110A, low visibility due to improper lighting at the first charging point 110A and the like)

In an alternate exemplary embodiment, if the first vehicle 106A travelled to the location from the first charging point 110A at the historical charging event and where the location corresponds to one of the home of the user 114, the grocery store, or the movie theater, then this may indicate that the user 114 successfully completed the charging of the first vehicle 106A at the first charging point 110A. Therefore, such a charging point may be a suitable charging point for a charging event in future.

In an embodiment, the apparatus 102 may be configured to determine the destination information associated with each vehicle of the set of vehicles 106 at the corresponding charging point. Further, the apparatus 102 may be configured to determine destination information associated with each charging point of the set of charging points 110 and store the destination information associated with each charging point of the set of charging points in one or more sources 104.

In an embodiment, the set of features 302A may further include the fourth feature. The fourth feature may be indicative of the parking information associated with each charging point of the set of charging points 110. The apparatus 102 may determine using the one or more sources 104, the parking information associated with each charging point of the set of charging points 110. The parking information may indicate if there is a parking space available at the corresponding charging point. Further, the parking information may indicate if users faced any difficulty in parking the set of vehicles 106 at the corresponding charging point during historical charging event.

In an exemplary embodiment, the apparatus 102 may be configured to retrieve, using the one or more sources 104, the parking information associated with the first charging point 110A of the set of charging points 110. The parking information associated with the first charging point 110A of the set of charging points 110 may indicate availability of the parking space at the first charging point 110A. The one or more sources 104 for retrieval of the parking information at the first charging point 110A may correspond to, for example, but not limited to, satellite imagery, historical probe data, or crowdsourcing. In one scenario, the apparatus 102 may determine, using the satellite imagery, if the first charging point 110A is located in a location where the parking space is available or where the parking space is congested. In another scenario, the apparatus 102 may utilize crowdsourcing to determine if the first charging point 110A is located in the location where the parking space is available. Similarly, the apparatus 102 may retrieve the parking information associated with each of the set of charging points 110.

In an embodiment, the set of features 302A may further include the fifth feature. The fifth feature may correspond to the functional class of the road segment associated with each charging point of the set of charging points 110. The functional class associated with the road segment may categorize the road segment based on its intended purpose and role within the transportation network. Functional classification may define how a particular roadway segment functions in terms of serving traffic flow and providing access to adjacent properties. The road segments may be grouped into different classes within a hierarchy, such as principal arterial, minor arterial, collector (major and minor), and local roads. Each class has specific characteristics and functions, with the principal arterials serving as major throughways for long-distance travel, the collectors connecting local roads to higher-class roads, and the local roads catering to local traffic needs.

Further, the functional class (or the class feature) may be a road type indicator that may reflect a traffic speed and a traffic volume, as well as the importance and connectivity of the road segment associated with each of the set of charging points 110. The functional class of the road segment may be a numerical value ranging from 1 to 5. For example, the functional class “1” may indicate a road with a high-volume traffic, and a maximum-speed traffic. The functional class “2” may indicate a road with a high volume, and a high-speed traffic. The functional class “3” may indicate a road with a high-volume traffic. The functional class “4” may indicate a road with a high-volume traffic at moderate speeds between neighborhoods and the functional class “5” may indicate a road whose volume and traffic flow may be below the level of any other functional class.

In an embodiment, the apparatus 102 may use the one or more sources 104 to retrieve the functional class of the road segment associated with each charging point of the set of charging point 110. In an embodiment, the one or more sources 104 may be used for the retrieval of the functional class of the road segment may be for example, but not limited to, the map database 108B. In an exemplary embodiment, if the retrieved functional class of the road segment associated with the first charging point 110A may indicate that the road segment may correspond to the principal arterial class (such as functional class “1”), then this may indicate that the first charging point 110A is not safe to park and charge the first vehicle 106A because the road segments tagged as functional class “1” may have high-volume traffic at high speeds which may be undesirable for the user 114 especially if there are kids along with the user 114. In an embodiment, the parking and charging the first vehicle 106A at the first charging point 110A may be risky for the user 114 as well as the first vehicle 106A as the road segment characterized as the principal arterial may have a high speed limit (such as 50 miles/hour). In another exemplary embodiment, if the retrieved functional class of the road segment associated with the first charging point 110A may indicate that the road segment may correspond to the local road (such as functional class “5”), then this may indicate that the first charging point 110A is safe to park and charge the first vehicle 106A. The functional class “5” may indicate that the road segment associated with the first charging point 110A may allow low volume of traffic movement and the speed limit may be less. In such a case, parking and charging the first vehicle 106A at the first charging point 110A may not be risky for the user 114 as well as the first vehicle 106A as the road segment characterized as the local road that may have a low speed limit (such as 20 miles/hour).

In an embodiment, the apparatus 102 may determine using one or more sources 104 and the probe data 204A, the sixth feature of the set of features 302A associated with each charging point of the set of charging points 110. The sixth feature may be associated with the accessibility information for each charging point of the set of charging points 110. In an exemplary embodiment, the accessibility information may indicate the ease of access to the corresponding charging point of the set of charging points 110.

In an exemplary scenario, if the user 114 of the first vehicle 106A faced obstacles to drive the first vehicle 106A from the first location to the first charging point 110A, then the accessibility information may indicate that the first charging point 110A may be inaccessible. The obstacles may be, for example, but are not limited to, a narrow road segment, construction material within the vicinity of the first charging point 110A, disorganized surrounding within the vicinity of the first charging point 110A, and the like. The accessibility information may be determined based on for example, but not limited to, a time taken by the first vehicle 106A from the first location to reach the first charging point 110A, distance between the first location and the first charging point 110A, number of maneuvers made by the user 114 from the first location to the first charging point 110A. In an embodiment, the first location may be the location of the first vehicle 106A when the recommendation process for the one or more charging points got initiated in the historical time period. The historical time period may be for example, but not limited to, 1 month, 2 months, and the like. In another embodiment, the first location may be a parking lot within a vicinity of the first charging point 110A. In an embodiment, the first charging point 110A may be inaccessible if there is an Internal Combustion Engine (ICE) vehicle blocking a pathway to the first charging point 110A.

In an additional embodiment, the apparatus 102 may use the probe data 204A to differentiate between local people associated with a particular city where the set of charging points may be installed and tourists travelling to the particular city. The differentiation may be made based on the familiarity of the corresponding user (whether local or tourist) with the area and their interaction with the one or more charging points within the area of the particular city. For example, the local people associated with the particular city, may be familiar with the area, might anticipate the availability of the corresponding charging point from a distance (say 100 meters). If they predict a struggle due to the number of vehicles already parked, they might decide not to travel to the corresponding charging point and opt for another charging point. Further, the apparatus 102 may observe that the local people may tend to use certain entries while the tourists may struggle to find the charging point, or the tourist may park improperly. In an embodiment, such behavior may be determined from the probe data 204A. The apparatus 102 may be configured to capture the “intelligence” of the local people. In an exemplary embodiment, the local people may be familiar with the movement of the traffic and the availability of one or more charging points within their locality. The local people familiar with their locality may avoid certain charging points due to specific reasons. The specific reasons may be, for example, but not limited to, no parking space or congested parking space at the set of charging points 110. The apparatus 102 may learn the charging pattern of the local people and recommend the one or more charging points that might be available. Similarly, the apparatus 102 may provide navigational guidance and information to the user 114 based on whether the user 114 may be driving to their home area or when they are travelling to an unfamiliar location. This may further enhance the user experience by providing personalized and location-specific insights to the user 114.

In an embodiment, the apparatus 102 may provide the retrieved set of features 302A as input 302 to the machine learning model 102A for training. The apparatus 102 may train the machine learning model 102A in historical time. The apparatus 102 may assign suitability weight to each of the set of features 302A. The machine learning model 102A may provide an output 304 that may include a suitability score 304A associated with each of the set of charging points 110. The apparatus 102 may further utilize the suitability score 304A generated by the machine learning model 102A to generate one or more recommendations associated with the one or more charging points.

In an embodiment, the apparatus 102 may assign the suitability weight to the first feature of the set of features 302A. For example, the suitability weight associated with the first feature may lie between 0 and 1. Further, there may be a feature value corresponding to each type of the point of interest (with suitability weight 1). In an exemplary embodiment, the feature value corresponding to the liquor store may be 0.1, the feature value corresponding to the smoking zone may be 0.2, the feature value corresponding to the adult entertainment zone may be, 0, the feature value corresponding to the grocery store may be 0.5, the feature value corresponding to the children play ground may be 0.5, the feature value corresponding to the movie theater may be 0.5.

In a scenario, if the point of interest within the second distance (such as 100 meters) of the first charging point 110A may be, for example, the liquor store, then product of the suitability weight of the first feature and the feature value of the corresponding point of interest (the liquor store) may be (1*0.1=0.1). In another scenario, if the point of interest within the second distance (such as 100 meters) of the first charging point 110A may be, for example, the adult entertainment zone, then product of the suitability weight of the first feature and the feature value of the corresponding point of interest (the adult entertainment zone) may be (1*0 =0). In yet another scenario, if the point of interest within the second distance (such as 100 meters) of the first charging point 110A may be, for example, the grocery store, then product of the suitability weight of the first feature and the feature value of the corresponding point of interest (the grocery store) may be (1*0.5=0.5).

In an embodiment, the apparatus 102 may assign the suitability weight to the second feature (average duration of time spent by the set of vehicles 106 at the corresponding charging point). The suitability weight associated with the second feature may be, for example, but not limited to, 0.5. Further, if the average duration of time spent by the set of vehicles 106 at the corresponding charging point may be less than the pre-determined threshold, then the feature value associated with the corresponding charging point may be for example, 0.1. If the average duration of time spent by the set of vehicles 106 at the corresponding charging point may be greater than the pre-determined threshold, then the feature value associated with the corresponding charging point may be for example, 0.2.

In a scenario where the average duration of time spent by the set of vehicles 106 at the first charging point 110A may be less than the pre-determined threshold, then the product of the suitability weight of the second feature and the feature value may be (0.5*0.1=0.05). In another scenario, if the average duration of time spent by the set of vehicles 106 at the first charging point 110A may be greater than the pre-determined threshold, then the product of the suitability weight and the feature value may be (0.5*0.2=0.1).

In an embodiment, the apparatus 102 may assign the suitability weight to the third feature (the destination information associated with the corresponding charging point). The suitability weight associated with the third feature may be, for example, but not limited to, 1. Further, if the destination information may correspond to the police station, the feature value assigned to the corresponding charging point may be, for example, 0.1. Further, if the destination information may correspond to the hospital, the feature value assigned to the corresponding charging point may be, for example, 0.2. If the destination information may correspond to the second charging point 110B, the feature value assigned to the corresponding charging point may be, for example, 0.3. Further, if the destination information may correspond to the home of the user 114, the feature value assigned to the corresponding charging point may be, for example, 0.5.

In a scenario, where the first vehicle 106A travelled from the first charging point 110A to the police station, the product of the suitability weight and the feature value may be (1*0.1=0.1). In other scenario, where the first vehicle 106A travelled from the first charging point 110A to the home of the user 114, the product of the suitability weight and the feature value may be (1*0.5=0.5).

In an embodiment, the apparatus 102 may assign the suitability weight to the fourth feature (the parking information). The suitability weight may be, for example, but not limited to, 0.6. Based on the retrieved parking information, the apparatus 102 may assign a feature value to the corresponding charging point. For example, if the parking information indicates that there is parking spot available within the vicinity of the corresponding charging point, then the feature value assigned may be, for example, 0.5. Further, if the parking information indicates that there is no parking spot available within the vicinity of the corresponding charging point, then the feature value assigned may be, for example, 0.1.

In a scenario, where the retrieved parking information indicates that there is no parking spot available within the vicinity of the first charging point 110A for the user 114 to park and charge the first vehicle 106A, the product of the suitability weight and the feature value may be, for example, (0.6*0.1=0.06). In another scenario, where the retrieved parking information indicates that there is parking spot available within the vicinity of the first charging point 110A for the user 114 to park and charge the first vehicle 106A, the product of the suitability weight and the feature value may be, for example, (0.6*0.5=0.3).

In an embodiment, the apparatus 102 may assign the suitability weight to the fifth feature (the functional class of the road segment). The suitability weight may be, for example, but not limited to, 1. In an exemplary embodiment, if the functional class of the road segment associated with the corresponding charging point may correspond to the principal arterial, the feature value assigned to the corresponding charging point may be, for example, 0.1. In another exemplary embodiment, if the functional class of the road segment associated with the corresponding charging point may correspond to the local road, the feature value assigned to the corresponding charging point may be, for example, 0.5.

In a scenario, where the retrieved fifth feature may indicate that the functional class of the first charging point 110A may correspond to the principal arterial, then the product of the suitability weight and the feature value may be, for example (1*0.1=0.1). In another scenario, where the retrieved fifth feature may indicate that the functional class of the first charging point 110A may correspond to the local road, then the product of the suitability weight and the feature value may be, for example (1*0.5=0.5).

In an embodiment, the apparatus 102 may be configured to assign the suitability weight to the sixth feature (the accessibility information). The suitability weight may be, for example, but not limited to, 0.5. In an exemplary embodiment, if the determined accessibility information may indicate that the corresponding charging point may be inaccessible, then the apparatus 102 may assign the feature value to the corresponding charging point. The assigned feature value may be, for example, 0.1. In an exemplary embodiment, if the determined accessibility information may indicate that the corresponding charging point may be accessible, then the apparatus 102 may assign the feature value to the corresponding charging point. The assigned feature value may be, for example, 0.5.

In an embodiment, the apparatus 102 may provide as input 302, the retrieved set of features 302A to the machine learning model 102A. The machine learning model 102A may be applied on the retrieved set of features 302A. The machine learning model 102A may calculate a suitability score 304A that may be utilized by the apparatus 102 to generate the one or more recommendations associated with the one or more charging points of the set of charging points 110. The apparatus 102 may be configured to pre-train the machine learning model 102A on the retrieved set of features 302A in the historical time period.

In an embodiment, the apparatus 102 may retrieve the set of features 302A associated with the first charging point 110A. in an exemplary embodiment, the establishment information of the first feature (points of interest) associated with the first charging point 110A may correspond to the liquor store, the second feature (average duration of time spent by the set of vehicles 106) at the first charging point 110A may correspond to less than the pre-determined threshold value, the third feature (the destination information) from the first charging point 110A may correspond to the hospital, the fourth feature (the parking information) associated with the first charging point 110A may be retrieved as no parking spot available, the fifth feature (the functional class of the road segment) may be retrieved as the principal arterial, and the sixth feature (the accessibility information) may be determined as inaccessible. Further, the machine learning model 102A may calculate the suitability score 304A associated with the first charging point 110A by adding the product (suitability weight * feature value) of each of the set of features 302A.

Further, the suitability score 304A associated with the first charging point 110A may be, for example, (1*0.1)+(0.5*0.1)+(1*0.1)+(0.6*0.1)+(1*0.1)+(0.5*0.1)=(0.1)+(0.05)+(0.1)+(0.06)+(0.1)+(0.05). The suitability score 304A that may be calculated and generated by the machine learning model 102A may be 0.46.

In another embodiment, the apparatus 102 may calculate the suitability score 304A corresponding to each of the set of charging points 110. Further, the apparatus 102 may train the machine learning model 102A based on the set of features 302A associated with each of the set of charging points 110 and the suitability score 304A associated with the corresponding charging point. For example, the apparatus 102 may provide as input 302, the set of feature 302A associated with the first charging point 110A and the suitability score 304A associated with the first charging point 110A to train the machine learning model 102A.

FIG. 3B is a diagram 300B that illustrates a block diagram that shows operations for determination of average time duration of the set of vehicles 106 at the set of charging points 110 based on the probe data 204A, in accordance with an embodiment of the disclosure. FIG. 3B is explained in conjunction with elements from FIG. 1, FIG. 2, and FIG. 3A. The operations may start at 306.

At 306, the apparatus 102 may be configured to acquire the probe data 204A to determine the average duration of time spent by the set of vehicles 106 at first charging point 110A of the set of charging points 110 during historical charging events. The probe data 204A may be associated with the set of vehicles 106. In an embodiment, the map database 108B may include the probe data 204A of the historical charging events associated with the set of vehicles 106. The probe data 204A may be used to determine the arrival time and the departure time of each vehicle of the set of vehicles 106 at the corresponding charging point in the historical charging event.

At 308, average time determination operation may be executed. In an embodiment, the apparatus 102 may be configured to determine, using the probe data 204A, the average duration of time spent by the set of vehicles 106 at the first charging point 110A of the set of charging points 110. The average time duration of the set of vehicles 106 at the first charging point 110A may be determined using the probe data 204A associated with the historical charging events of the set of vehicles 106 at the first charging point 110A.

In an exemplary embodiment, using the probe data 204A, the arrival time information and the departure time information associated with each vehicle of the set of vehicles 106 at the corresponding charging point may be determined. Further, the apparatus 102 may be configured to calculate the time duration spent by each vehicle of the set of vehicles 106 at the corresponding charging station based on the determined arrival time information and the departure time information associated with the respective vehicle. For example, the arrival time information during the historical charging event and the departure time information during the historical charging event associated with the first vehicle 106A at the first charging point 110A may be, 15:30:00 and 16:00:00 respectively. Further, the arrival time information at the historical charging event and the departure time information at the historical charging event associated with the second vehicle 106B at the first charging point 110A may be, 10:00:00 and 10:40:00 respectively. The determined time duration spent by the first vehicle 106A at the first charging point 110A may be 30 mins and the time duration spent by the second vehicle 106B at the first charging point 110A may be 40 mins. Further, the apparatus 102 may be configured to determine, using the calculated duration of time spent by the first vehicle 106A and the second vehicle 106B, the average duration of time spent by the set of vehicles 106 associated with the corresponding charging point. For example, the average duration of time spent by the set of vehicles 106 associated with the first charging point 110A may be 35 mins.

At 310, charging point information storage operation may be executed. In an embodiment, the apparatus 102 may be configured to store the charging point information in the one or more sources 104. The one or more sources 104 may be, for example, but not limited to, a database associated with vendors of the set of charging points 110, the map database 108B, an OEM database associated with the set of vehicles 106, and the like. In an exemplary embodiment, the apparatus 102 may store the average duration of time spent by the set of vehicles 106 corresponding to each of the respective set of charging points 110 in the one or more sources 104 on a periodic basis. As discussed above in FIG. 3A, the average time duration may be a feature on which the machine learning model 102A may be trained.

FIG. 3C is a diagram 300C that illustrates a block diagram depicting operations associated with determination of second location information from an electronic device 312 associated with the user 114, in accordance with an embodiment of the present disclosure. FIG. 3C is explained in conjunction with elements from FIG. 1, FIG. 2, FIG. 3A, and FIG. 3B.

In an embodiment, the apparatus 102 may be configured to obtain second location information 314 from an electronic device 312 that may be associated with the user 114. The second location information 314 may indicate a location of the user 114 of the first vehicle 106A at the corresponding charging point of the set of charging points 110 during the historical charging event.

In an exemplary embodiment, once the user 114 may initiate the charging process of the first vehicle 106A at the first charging point 110A, the apparatus 102 may obtain the second location information 314 from the electronic device 312 associated with the user 114. The electronic device 312 may be, for example, but not limited to, a smartphone, a tablet and a smartwatch that may be associated with the user 114. The apparatus 102 may obtain the second location information 314 for the first time period. The first time period may be, for example, but not limited to, 10 mins, 20 mins, 30 mins, and 40 mins. In another example, the first time period may be equal to duration of charging of the first vehicle 106A at the first charging point 110A.

At 316, the apparatus 102 may be further configured to determine mobility information associated with a mobility of the user 114 during the first time period based on the obtained second location information 314. In an exemplary embodiment, based on the second location information 314 being same as the location of the first vehicle 106A for the first time period, the mobility information may indicate that the user 114 of the first vehicle 106A is sitting in first vehicle 106A during the entire charging process of the first vehicle 106A at the first charging point 110A. In an embodiment, the second location information 314 being same as the first vehicle 106A may indicate that the user 114 may have felt unsafe to move out of the first vehicle 106A during the charging process of the first vehicle 106A at the first charging point 110A. The user 114 may have felt unsafe for several reasons such as, but not limited to, improper visibility within the vicinity of the first charging point 110A, presence of suspected personalities within the vicinity of the first charging point 110A, and unsuitable points of interest within the vicinity of the first charging point 110A. The unsuitable points of interest may be, for example, but not limited to, the liquor store, the adult entertainment zone, the smoking zone, and the like.

In another exemplary embodiment, if the user 114 of the first vehicle 106A may visit a second location during the charging process of the first vehicle 106A at the first charging point 110A, where the second location may be, the point of interest within the vicinity of the first charging point 110A, then the apparatus 102 may obtain the second location information 314 from the electronic device 312 associated with the user 114. The points of interest may be, but not limited to, the shopping mall and the grocery store. The apparatus 102 may be configured to determine the mobility information associated with the mobility of the user during the first time period based on the obtained second location information 314. For example, the apparatus 102 may be configured to determine the location of the electronic device 312 at a first timestamp and a location of the electronic device 312 at a second timestamp. The first timestamp may correspond to the time when the user 114 may be at the location of the first vehicle 106A at the first charging point. Further, the second timestamp may correspond to the time when the user 114 may have reached the second location. In an exemplary embodiment, based on the mobility information the apparatus 102 may determine a distance of the second location from the location of the first vehicle 106A. The apparatus 102 may compare the determined distance between the second location and the first vehicle 106A with a pre-defined distance threshold. The pre-defined distance threshold may be, but not limited to, 100 meter, 200 meter, and 300 meter. For example, if the determined distance is greater than the pre-defined threshold, then this may indicate that the second location is far from the first charging point 110A which may cause inconvenience for the user 114 and other upcoming users. In another example, if the determined distance is less than the pre-defined threshold, then this may indicate that the second location is closer from the first charging point 110A which may be convenient for the user 114 and other upcoming users.

Further, the apparatus 102 may be configured to perform the charging point information update operation 318. In an embodiment, the apparatus 102 may be configured to update the charging point information associated with the corresponding charging point of the set of charging points 110. In an exemplary embodiment, the apparatus 102 may update the charging point information based on the determined mobility information of the user 114 during at least one historical charging event at the first charging point 110A. For example, if the compared distance travelled by the user 114 from the location of the first vehicle 106A to the second location is greater than the pre-defined distance threshold, than it may indicate of the second location may be far from the first charging point 110A. Further, based on the second location being far from the first charging point 110A, the apparatus 102 may classify the first charging point 110A as unsuitable charging point.

In another exemplary embodiment, if the compared distance travelled by the user 114 from the location of the first vehicle 106A to the second location is less than the pre-defined distance threshold, then it may indicate that the second location may be near the first charging point 110A. Further, based on the second location being near the first charging point 110A, the apparatus 102 may classify the first charging point 110A as the suitable charging point for upcoming charging events. In an embodiment, updating the charging point information may be the process of updating the feature values associated with the set of features 302A.

In an embodiment, the apparatus 102 may be configured to update the charging point information for a pre-defined time period. The pre-defined time period may be, for example, but not limited to, 1 day, 2 days, 3 days, 1 week, 1 month, and the like.

In an embodiment, the apparatus 102 may be further configured to execute the updated charging point information storage operation 320. In an embodiment, the apparatus 102 may be configured to store the updated charging point information in the one or more sources 104. The one or more sources 104 may be, for example, but not limited to, the database. In an exemplary embodiment, the apparatus 102 may store the determined mobility information corresponding to each charging point of the set of charging points 110 in the one or more sources 104. As discussed above in FIG. 3A, the mobility information may be a feature on which the machine learning model 102A may be trained.

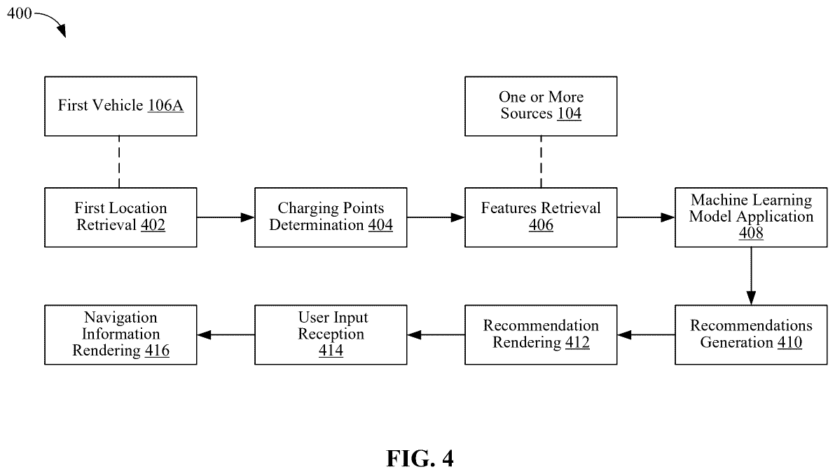

FIG. 4 is a block diagram 400 that illustrates a block diagram depicting operations associated with the retrieval of set of features 302A using one or more sources 104 and applying the machine learning model 102A on the retrieved set of features 302A to generate one or more recommendations associated with the one or more charging points, in accordance with an embodiment of the disclosure. FIG. 4 is explained in conjunction with elements from FIG. 1 and FIG. 2, FIG. 3A, FIG. 3B, and FIG. 3C.

In an embodiment, the user 114 of the first vehicle 106A may be travelling from a location ‘A’ to a location ‘B’. While travelling from the location A to the location B, the user 114 may need to charge the first vehicle 106A. In one scenario, the user 114 may initiate the recommendation process of the one or more charging points by providing a user input to the apparatus 102. In another scenario, the recommendation process may be automatically triggered if the battery charge level of the first vehicle 106A may fall below the battery charge level threshold. The apparatus 102 may start the recommendation process by performing the operations described below. The operations may start at 402.

At 402, the first location retrieval operation may be executed. In the first location retrieval operation, the apparatus 102 may be configured to execute the first location retrieval operation. In an embodiment, the apparatus 102 may retrieve the first location associated with the first vehicle 106A of the set of vehicles 106. The first location may correspond to the current location of the first vehicle 106A. The first location associated with the first vehicle 106A may be retrieved from the GNSS or GPS systems installed in the first vehicle 106A.

At 404, charging points determination operation may be executed. In the charging point determination operation, the apparatus 102 may determine the set of charging points 110 within the first distance of the first vehicle 106A based on the retrieved first location of the first vehicle 106A. For example, if the first vehicle 106A may be at ‘A’, then the apparatus 102 may determine the set of charging points 110 within the first distance of the first vehicle 106A based on the retrieved first location ‘A’ of the first vehicle 106A. In an embodiment, the first distance may be, for example, but not limited to, 1 mile, 2 miles, 3 miles, 4 miles, 5 miles, or 10 miles.

The apparatus 102 may determine the set of charging points within the first distance of the first location associated with the first vehicle 106A. If there are 10 charging points within the first distance of the first location, the apparatus 102 may determine each of the 10 charging points and further retrieve the set features 302A associated with each charging points.

At 406, feature retrieval operation may be executed. the apparatus 102 may be configured to retrieve the set of features 302A associated with each charging point within the first distance of the first vehicle 106A. The set of features 302A may be retrieved from the one or more sources 104. In an exemplary embodiment, the set of features 302A associated with the first charging point 110A may be, for example, one or more points of interests within the second distance of the first charging point 110A, the second feature associated with average duration of time spent by the set of vehicles 106 at the first charging point 110A, the third feature associated with the destination information of the set of vehicles 106 from the first charging point 110A, the fourth feature indicative of the parking information associated with the first charging point 110A, the fifth feature associated with the functional class of the road segment associated with the first charging point 110A, and the sixth feature associated with the accessibility information of the first charging point 110A. The details about each of the set of features 302A are described in FIG. 3A.

At 408, machine learning model application may be performed. The apparatus 102 may be configured to apply the machine learning model 102A on the retrieved set of features 302A associated with the set of charging points 110 within the first distance of the first vehicle 106A. The application of the machine learning model 102A may generate the suitability score 304A associated with each of the charging point within the first distance of the first vehicle 106A. The suitability score 304A may be utilized to classify each of the charging point as the suitable charging point, or the unsuitable charging point. The details about the machine learning model 102A to generate the suitability score 304A are provided, for example, in FIG. 3A.

At 410, recommendation generation operation may be executed. In an embodiment, the apparatus 102 may be configured to execute the recommendation generation operation. In the recommendation generation operation, the apparatus 102 may be configured to generate one or more recommendations associated with one or more charging points of the set of charging points 110 based on the suitability score 304A generated based on the application of the machine learning model 102A on the retrieved set of features 302A.

In an exemplary embodiment, the suitability score 304A may range from 0 to 1. In a scenario, where the suitability score 304A may be closer to 0, this may indicate that the corresponding charging point may be the unsuitable charging point. Further, if the suitability score 304A may be closer to 10, this may indicate that the corresponding charging point may be the suitable charging point. Further, if the apparatus 102 may determine four charging points (such as, the first charging point 110A, the second charging point 110B, third charging point and fourth charging point) within the first distance of the first vehicle 106A, and the suitability score 304A corresponding to each of the determined charging point may be, for example, 0.6, 0.5, 0.4, 0.3, 0.2 respectively, then the apparatus 102 may be configured to generate a first recommendation corresponding to the first charging point 110A as the first charging point 110A has the higher suitability score. Further, the apparatus 102 may be configured to generate a second recommendation corresponding to the second charging point 110B as the second charging point 110B may have a second highest suitability score. Similarly, the apparatus 102 may be configured to generate a third recommendation and a fourth recommendation corresponding to the third charging point and the fourth charging point, respectively.

At 412, recommendation rendering operation may be executed. In an embodiment, the apparatus 102 may be configured to execute the recommendation rendering operation. In the recommendation rendering operation, the apparatus 102 may be configured to provide, via the user interface, the generated one or more recommendations as an option for selection by the user 114.

In an exemplary embodiment, each recommendation of the one or more recommendation may be associated with only one charging point. As discussed above, the first recommendation may correspond to the first charging point 110A of the set of charging points 110 within the first distance of the first location associated with the first vehicle 106A, the second recommendation may correspond to the second charging point 110B of the set of charging points 110 within the first distance of the first location associated with the first vehicle 106A. The apparatus 102 may provide, via the user interface, the generated first recommendation and the generated second recommendation as an option for selection by the user 114. In an example, the user interface may be associated with an infotainment system of the first vehicle 106A. In an example, the user interface may be associated with the electronic device 312 associated with the user 114 of first vehicle 106A. Details about providing the one or more recommendations are described, for example, in FIG. 6A.

At 414, user input reception operation may be executed. In an embodiment, the apparatus 102 may receive a first user input associated with the selection of the first recommendation of the one or more recommendations. The first user input may be received via the user interface. The first recommendation may be associated with the first charging point 110A of the set of charging points 110. Specifically, the first charging point 110A of the set of charging points 110 may be recommended in the first recommendation.

In an exemplary embodiment, the processor 202 may provide the first recommendation associated with the first charging point 110A, and the second recommendation associated with the second charging point 110B on the user interface associated with the first vehicle 106A. The first recommendation and the second recommendation may be provided as an option for selection by the user 114 of the first vehicle 106A. The apparatus 102 may receive an input associated with the selection of one recommendation of the one or more recommendations from the user 114, via the user interface. For example, the user 114 may select the first recommendation associated with the first charging point 110A of the set of charging points 110. Details about selection of a recommendation are provided, for example, in FIG. 6A.

At 416, navigation information rendering operation may be executed. In an embodiment, the apparatus 102 may be configured to execute the navigation information rendering operation. In the navigation information rendering operation, the apparatus 102 may be configured to provide, via the user interface, the navigation information associated with navigation from the first location to the first charging point 110A based on the received first user input. The navigation information may encompass the planning and execution of routes leading towards the first charging point 110A. The navigation information may further include details about the first vehicle 106A, such as, but not limited to, a speed, a direction, and a position, as well as information about the navigation route, such as a distance, a time, and any obstacles or hazards along the way from the first location to the first charging point 110A. In an exemplary embodiment, based on the selection of the charging point from the generated one or more recommendations, the apparatus 102 may provide navigation information from the first location to the selected charging point via the user interface associated with the first vehicle 106A.

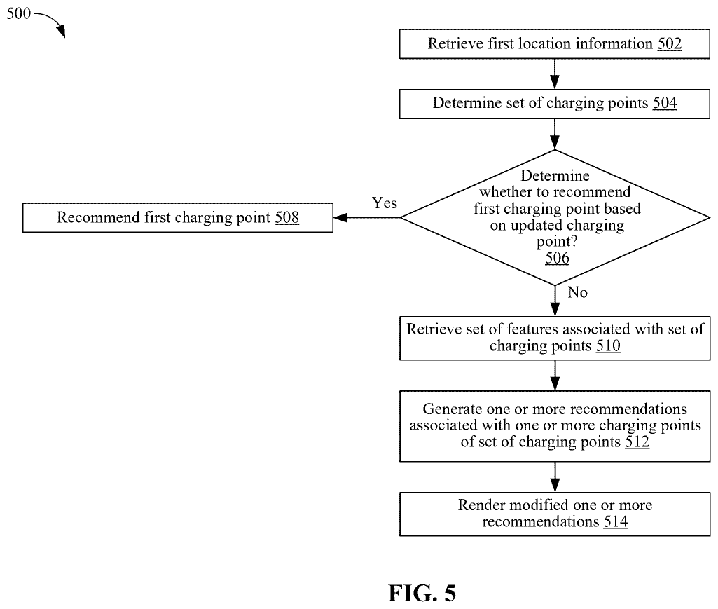

FIG. 5 illustrates a flowchart 500 that depicts rendering of one or more recommendations based on a change in the set of features 302A associated with the set of charging points 110, in accordance with an embodiment of the disclosure. FIG. 5 is explained in conjunction with elements from FIGS. 1, 2, 3A, 3B, 3C, and 4.

At 502, the apparatus 102 may be configured to retrieve the first location information. In an exemplary embodiment, the first location information may be associated with the first vehicle 106A. The first location of the first vehicle 106A may be the current location of the first vehicle 106A from where the recommendation process for the charging points may be initiated.

At 504, the apparatus 102 may be further configured to determine the set of charging points 110. The apparatus 102 may determine the set of charging points 110 within the first distance of the first location of the first vehicle 106A. In an exemplary embodiment, based on the first distance being set to 5 miles, the apparatus 102 may determine the set of charging points within 5 miles of the retrieved first location. For example, if there are four charging points within 5 miles of the first location of the first vehicle 106A, the apparatus 102 may determine the first charging point 110A, and the second charging point 110B. Further, the apparatus 102 may be configured to determine the suitability score 304A corresponding to each charging point of the set of charging points 110 within the first distance of the first location.

At 506, the apparatus 102 may be configured to determine whether to recommend the first charging point 110A based on the updated charging point. For example, during a first historical charging point recommendation operation, the establishment information associated with a first points of interest of the one or more points of interest within the second distance of the first charging point 110A may be the liquor store. The first historical charging point recommendation operation may take place 7 days before the current day of operation. As the liquor store may be an unsuitable point of interest, the apparatus 102 may have assigned a low suitability score 304A to the corresponding charging point.

Further, during a second historical charging point recommendation operation, the establishment information associated with the points of interest within the second distance of the first charging point 110A may be the grocery store. The second historical charging point recommendation operation may take place 2 days before the current day of operation. The apparatus 102 may determine the modification in the establishment information based on the updated establishment information. As the grocery store may be the suitable point of interest, the apparatus 102 may have assigned the high feature value (0.5) to the corresponding feature, resulting in the high suitability score 304A of the first charging point 110A in the second historical charging. The suitability score 304A in the first historical charging point recommendation operation may be, for example, 0.3. As the suitability score 304A of the first charging point 110A in the second historical charging point recommendation operation may be high (such as 0.6), the first charging point 110A may be the suitable charging point. The apparatus 102 may modify the recommendation associated with the first charging point 110A based on the updated charging point information.

Similarly, the apparatus 102 may determine, using the probe data 204A, the average duration of time spent by the set of vehicles 106 at the first charging point 110A in the first historical charging point recommendation operation, and the second historical charging point recommendation operation. For example, in the first historical charging point recommendation operation, if the average duration of time spent by the set of vehicles 106 at the first charging point 110A may be less than the pre-determined threshold, then the apparatus 102 may have assigned the low feature value to the corresponding feature, resulting in the low suitability score 304A of the first charging point 110A.

Further, in the second historical charging point recommendation operation, if the average duration of time spent by the set of vehicles 106 may be equal to or higher than the pre-determined threshold, then the apparatus 102 may have assigned the high feature value to the corresponding feature, resulting in the high suitability score 304A of the first charging point 110A. In an embodiment, the first historical charging point recommendation operation may take place before the second historical charging point recommendation operation. Further, the apparatus 102 may update charging point information associated with the first charging point and store the updated charging point information in the one or more sources 104. The apparatus 102 may further recommend first charging point 110A based on the updated charging point information on the current day of operation.

In an embodiment, the apparatus 102 may retrieve, using one or more sources 104, the parking information associated with the first charging point 110A in the first historical charging point recommendation operation and the second historical charging point recommendation operation. For example, in the first historical charging point recommendation operation, if the first charging point 110A did not have enough parking space to park and charge the set of vehicles 106, then the apparatus 102 may have assigned the low feature value to the corresponding feature, resulting in the low suitability score 304A of the first charging point 110A.

Further, during the second historical charging point recommendation operation, if the apparatus 102 may determine that a new parking space was built within the vicinity of the first charging point 110A, resulting in ample amount of parking space to park and charge the set of vehicles 106 at the first charging point 110A, then the apparatus 102 may have assigned the high feature value to the corresponding feature, resulting in the high suitability score 304A of the first charging point 110A. In an embodiment, the first historical charging point recommendation operation may take place before the second historical charging point recommendation operation. Further, the apparatus 102 may update charging point information associated with the first charging point 110A and store the updated charging point information in the one or more sources 104. The apparatus 102 may further recommend the first charging point 110A based on the updated charging point information.

In an embodiment, the apparatus 102 retrieve, using one or more sources 104, the functional class of the road segment associated with the first charging point 110A in the first historical charging point recommendation operation and the second historical charging point recommendation operation. For example, during the first historical charging point recommendation operation, if the road segment associated with the first charging point 110A may correspond to the principal arterial (level 1), then the apparatus 102 may have assigned the low feature value to the corresponding feature, resulting in a low suitability score 304A of the first charging point 110A.

Further, during the second historical charging point recommendation operation, if the apparatus 102 may determine that the road segment associated with the first charging point 110A may correspond to the local road (level 4), then the apparatus 102 may have assigned the high feature value to the corresponding feature, resulting in a high suitability score 304A of the first charging point 110A. In an embodiment, the first historical charging point recommendation operation may take place before the second historical charging point recommendation operation. Further, the apparatus 102 may update charging point information associated with the first charging point and store the updated charging point information in the one or more sources 104. The apparatus 102 may further recommend the first charging point 110A based on the updated charging point information.

In an embodiment, the apparatus 102 may be configured to determine, using one or more sources 104, the accessibility information associated with the first charging point 110A in the first historical charging point recommendation operation and the second historical charging point recommendation operation. For example, during the first historical charging point recommendation operation, if the apparatus 102 determined that the set of vehicles had to face difficulty in accessing the first charging point 110A, then the apparatus 102 may have assigned the low feature value to the corresponding feature, resulting in the low suitability score 304A of the first charging point 110A.

Further, during the second historical charging point recommendation operation, if the apparatus 102 may determine that the set of vehicles 106 did not face any difficulty in accessing the first charging point 110A, then the apparatus 102 may have assigned the high feature value to the corresponding feature, resulting in the high suitability score 304A of the first charging point 110A. In an embodiment, the first historical charging point recommendation operation may take place before the second historical charging point recommendation operation. Further, the apparatus 102 may update charging point information associated with the first charging point and store the updated charging point information in the one or more sources 104. The apparatus 102 may further recommend the first charging point 110A based on the updated charging point information.

At 508, the apparatus 102 may be configured to recommend first charging point based on the suitability score 304A being the highest among all the determined set of charging points within the first distance of the first vehicle 106A on the current day of operation. In an exemplary embodiment, if the suitability score 304A associated with the first charging point 110A at the second charging event may be less than the suitability score 304A associated with the first charging point 110A at the first charging event, then the control of the operation may move to 510.

In an alternate embodiment, the apparatus 102 may have recommended the first charging point 110A to the user 114 associated with the first vehicle 106A during the first historical charging point recommendation operation. The first historical charging point recommendation operation may take place 7 days before the current day of operation. Further, upon reaching the first charging point 110A, the user 114 faced difficulty in parking the first vehicle 106A at the first charging point 110A. Due to insufficient parking space the user 114 left the first charging point 110A without charging the first vehicle 106A. The apparatus 102 may update the charging point information associated with the first charging point 110A. Further, based on the updated charging point information, the apparatus 102 may have determined that the average duration of time spent by the set of vehicles 106 at the first charging point 110A became less than the pre-determined threshold. Further, if the user 114 of the first vehicle 106A may initiate the recommendation process on the current day of operation, the apparatus 102 may not recommend the first charging point 110A to the user 114 for charging the first vehicle 106A based on the determination made by the apparatus 102 after the first historical charging point recommendation operation. In this scenario, the control may move to operation 510.

At 510, the apparatus 102 may retrieve the set of features 302A associated with the second charging point 110B of the set of charging points 110. The second charging point 110B may be located within the first distance of the first location. In an exemplary embodiment, the apparatus 102 may further determine the set of features 302A associated with the third charging point, and the fourth charging point. Further, the apparatus 102 may be configured to determine the suitability score 304A associated with each of the set of charging points within the first distance of the first location.

In an exemplary embodiment, the suitability score 304A associated with the second charging point 110B may be, for example, 0.5, the suitability score 304A associated with the third charging point may be 0.4, and the suitability score 304A associated with the fourth charging point may be 0.3. The apparatus 102 may determine that the second charging point 110B has the highest suitability score, the third charging point may have the second highest suitability score 304A and the fourth charging point may have the lowest suitability score.

At 512, the apparatus 102 may be configured to generate one or more recommendations associated with the one or more charging points of the set of charging points 110. As explained in the example above, the apparatus 102 may be configured to generate the first recommendation corresponding to the second charging point 110B, generate the second recommendation corresponding to the third charging point, generate the third recommendation corresponding to the fourth charging point.

At 514, the apparatus 102 may be configured to render the modified one or more recommendations via the user interface. The apparatus 102 may provide the modified one or more recommendations, via the user interface, as the option for selection by the user 114.

FIG. 6A depicts an exemplary scenario 600A for rendering one or more recommendations on the user interface of the first vehicle 106A, in accordance with an embodiment of the disclosure. FIG. 6A is explained in conjunction with elements from FIGS. 1, 2, 3A, 3B, 3C, 4, and 5.

In an embodiment, the user interface 602 associated with the first vehicle 106A may provide the one or more recommendations associated with the one or more charging points of the set of charging points 110 within the first distance of the first location of the first vehicle 106A. The one or more charging points may be recommended based on their corresponding suitability score 304A. For example, the one or more recommendations may include a first recommendation 604, a second recommendation 606, and a third recommendation 608. The first recommendation 604 may correspond to the most suitable charging point of the set of charging points 110 within the first distance of the first location of the first vehicle 106A. The most suitable charging point may correspond to the charging point that may have the highest suitability score 304A assigned to it by the machine learning model 102A. In an exemplary embodiment, the first recommendation 604 may specifically be associated with charging point ‘X’. Further, the second recommendation 606 may be associated with charging point ‘Y’, and the third recommendation 608 may be associated with charging point ‘Z’.

In an exemplary embodiment, the charging point ‘X’ may have a higher suitability score 304A than the charging point ‘Y’ and the charging point ‘Y’ may have a higher suitability score 304A than the charging point ‘Z’. Hence, then the first recommendation 604 may be associated with the charging point ‘X’, the second recommendation 606 may be associated with the charging point ‘Y’, and the third recommendation 608 may be associated with the charging point ‘Z’.

Further, the apparatus 102 may be configured to receive the first user input associated with the selection of the first recommendation 604 of the one or more recommendations. For example, the user 114 may select the first recommendation 604 associated with the charging point ‘X’. Further, the apparatus 102 may provide, via the user interface 602, the navigation information associated with navigation from the first location to the charging point ‘X’ based on the received first user input.

FIG. 6B depicts an exemplary scenario 600B for rendering navigational instructions from the first location to the location of the selected recommendation via the user interface 602 associated with the first vehicle 106A, in accordance with an embodiment of the disclosure. FIG. 6B is explained in conjunction with elements from FIGS. 1, 2, 3A, 3B, 3C, 4, 5, and 6A.

In an embodiment, once the apparatus 102 may receive, as input, the selected recommendation by the user 114, the apparatus 102 may provide, via the user interface 602, navigation information to the user 114 of the first vehicle 106A. The user 114 may navigate from the first location to the selected charging point ‘X’ to charge the first vehicle 106A. The user interface may provide a map that may illustrate the distance between the first location and the selected charging point ‘X.’ Further, the user interface 602 may illustrate the speed with which the first vehicle 106A may be currently travelling. The user interface 602 may further illustrate the amount of time the first vehicle 106A may take to reach the selected charging point ‘X’ based on the distance of the selected charging point ‘X’ and the current speed of the first vehicle 106A.

In an embodiment, once the user 114 the user interface 602 may further output a notification 610 that may render a message such as, but not limited to, “Charge the vehicle at the charging point X located at Bridge Street.
ETA to charging point X—2 min
Charge Duration—30 mins (approx.)”.

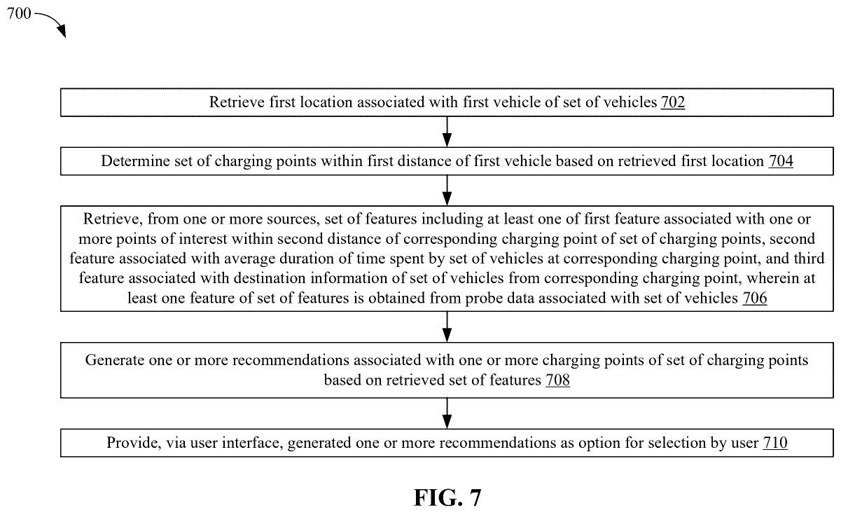

FIG. 7 is a flowchart 700 that illustrates an exemplary first method for recommending charging points based on probe data 204A, in accordance with an embodiment of the disclosure. FIG. 7 is explained in conjunction with elements from FIGS. 1, 2, 3A, 3B, 3C, 4, 5, 6A, and 6B. With reference to FIG. 7, there is shown the flowchart 700. The operations of the exemplary method may be executed by an apparatus, for example, the apparatus 102 of FIG. 1 or the processor 202 of FIG. 2. The operations of the flowchart 700 may start at 702.

At 702, the first location associated with the first vehicle 106A of the set of vehicles 106 may be retrieved. In an embodiment, the apparatus 102 may be configured to retrieve the first location associated with the first vehicle 106A of the set of vehicles 106. The details about the retrieval of the first location and the first vehicle 106A are provided, for example, in FIG. 1.

At 704, the set of charging points 110 within the first distance of the first vehicle 106A may be determined based on retrieved first location. In an embodiment, the apparatus 102 may be configured to determine the set of charging points 110 within the first distance of the first vehicle 106A based on the retrieved first location. The details about the determination of charging points are provided, for example, in FIG. 4.

At 706, the set of features 302A including at least one of the first feature associated with the one or more points of interest within the second distance of corresponding charging point of the set of charging points 110, the second feature associated with the average duration of time spent by the set of vehicles 106 at the corresponding charging point, and the third feature associated with the destination information of set of vehicles 106 from the corresponding charging point may be retrieved from the one or more sources 104. At least one feature of the set of features 302A may be obtained from probe data 204A associated with set of vehicles 106. In an embodiment, the apparatus 102 may be configured to retrieve, from one or more sources 104, set of features 302A including at least one of the first feature associated with the one or more points of interest within second distance of corresponding charging point of set of charging points 110, second feature associated with the average duration of time spent by the set of vehicles 106 at the corresponding charging point, and the third feature associated with the destination information of the set of vehicles 106 from the corresponding charging point. At least one feature of the set of features 302A may be obtained from the probe data 204A associated with the set of vehicles 106. The details about the set of features 302A are provided, for example, in FIG. 3A.

At 708, the one or more recommendations associated with the one or more charging points of set of charging points 110 may be generated based on the retrieved set of features 302A. In an embodiment, the apparatus 102 may be configured to generate the one or more recommendations associated with the one or more charging points of set of charging points 110 based on the retrieved set of features 302A. The details about generating the one or more recommendations are provided, for example, in FIG. 4, FIG. 5, and FIG. 6A.

At 710, the generated one or more recommendations may be provided, via the user interface, as option for selection by the user 114. In an embodiment, the apparatus 102 may be configured to provide, via the user interface, the generated one or more recommendations may be provided as option for selection by the user 114. The details about the providing the generated one or more recommendations to the user 114 are provided, for example, in FIG. 6A.

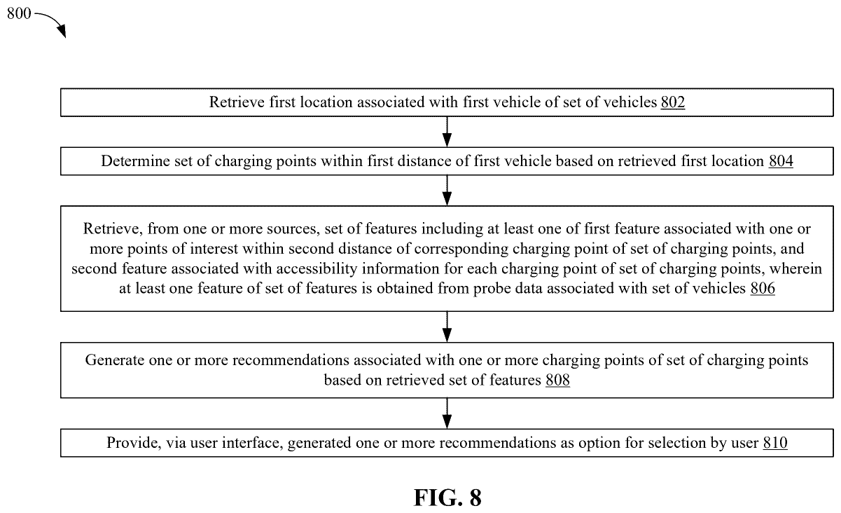

FIG. 8 is a flowchart 800 that illustrates an exemplary second method for recommending charging points based on probe data 204A, in accordance with an embodiment of the disclosure. FIG. 8 is explained in conjunction with elements from FIGS. 1, 2, 3A, 3B, 3C, 4, 5, 6A, 6B, and 7. With reference to FIG. 8 there is shown the flowchart 800. The operations of the exemplary method may be executed by an apparatus 102, for example, by apparatus 102 of FIG. 1 or the processor 202 of FIG. 2. The operations of the flowchart 800 may start at 802.

At 802, the first location associated with the first vehicle 106A of the set of vehicles 106 may be retrieved. In an embodiment, the apparatus 102 may be configured to retrieve the first location associated with the first vehicle 106A of the set of vehicles 106. The details about the retrieval of the first location and the first vehicle 106A are provided, for example, in FIG. 1.

At 804, the set of charging points 110 within the first distance of the first vehicle 106A may be determined based on retrieved first location. In an embodiment, the apparatus 102 may be configured to determine the set of charging points 110 within the first distance of the first vehicle 106A based on the retrieved first location. The details about the determination of charging points are provided, for example, in FIG. 4.

At 806, the set of features 302A including at least one of the first feature associated with the one or more points of interest within the second distance of the corresponding charging point of the set of charging points 110, and the second feature associated with the accessibility information for each charging point of the set of charging points 110 may be retrieved from the one or more sources 104. At least one feature of the set of features 302A may be obtained from the probe data 204A associated with set of vehicles 106. In an embodiment, the apparatus 102 may be configured to retrieve, from the one or more sources 104, the set of features 302A including at least one of the first feature associated with the one or more points of interest within the second distance of the corresponding charging point of the set of charging points 110, and the second feature associated with the accessibility information for each charging point of the set of charging points 110. The details about the set of features 302A are provided, for example, in FIG. 3A

At 808, the one or more recommendations associated with the one or more charging points of set of charging points 110 may be generated based on the retrieved set of features 302A. In an embodiment, the apparatus 102 may be configured to generate the one or more recommendations associated with the one or more charging points of set of charging points 110 based on the retrieved set of features 302A. The details about generating the one or more recommendations are provided, for example, in FIG. 4, FIG. 5, and FIG. 6A.

At 810, the generated one or more recommendations may be provided, via the user interface 602, as option for selection by the user 114. In an embodiment, the apparatus 102 may be configured to provide, via the user interface 602, the generated one or more recommendations as the option for selection by the user 114. The details about the providing the generated one or more recommendations to the user 114 are provided, for example, in FIG. 6A.

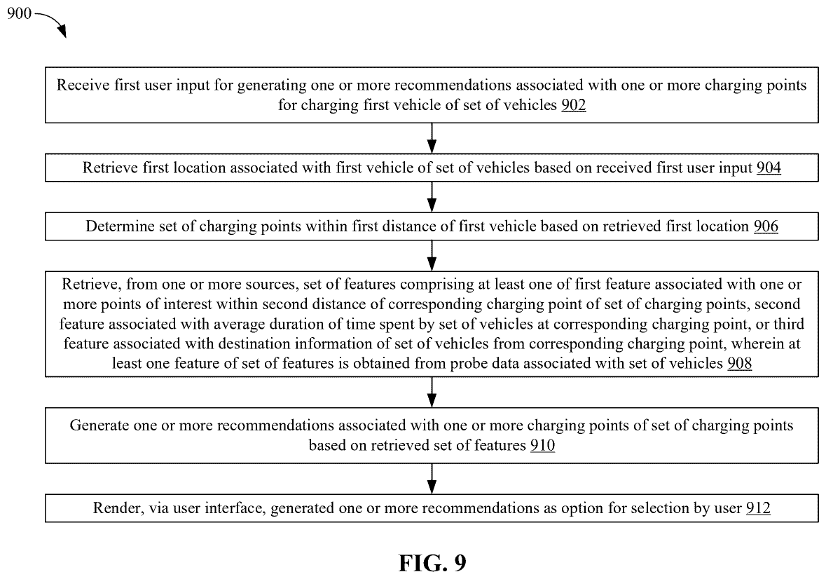

FIG. 9 is a flowchart 900 that illustrates an exemplary third method for recommending charging points based on probe data 204A, in accordance with an embodiment of the disclosure. FIG. 9 is explained in conjunction with elements from FIGS. 1, 2, 3A, 3B, 3C, 4, 5, 6A, 6B, 7, and 8. With reference to FIG. 9, there is shown the flowchart 900. The operations of the exemplary method may be performed by apparatus 102 of FIG. 1 or the processor 202 of FIG. 2. The operations of the flowchart 900 may start at 902.

At 902, the first user input for generating the one or more recommendations associated with the one or more charging points for charging the first vehicle 106A of the set of vehicles 106 may be received. In an embodiment, the apparatus 102 may be configured to receive the first user input for generating the one or more recommendations associated with the one or more charging points for charging the first vehicle 106A of the set of vehicles 106. Details about receiving the first user input are provided, for example, in FIG. 4, and FIG. 6A.

At 904, the first location associated with the first vehicle 106A of the set of vehicles 106 may be retrieved based on the received first user input. In an embodiment, the apparatus 102 may be configured to retrieve the first location associated with the first vehicle 106A of the set of vehicles 106 based on the received first user input. The details about retrieving the first location are provided, for example, in FIG. 4.

At 906, the set of charging points 110 within the first distance of the first vehicle 106A may be determined based on the retrieved first location. In an embodiment, the apparatus 102 may be configured to determine the set of charging points 110 within the first distance of the first vehicle 106A based on the retrieved first location. The details about determining the set of charging points 110 are provided, for example, in FIG. 4.

At 908, the set of features 302A including at least one of the first feature associated with the one or more points of interest within the second distance of corresponding charging point of the set of charging points 110, the second feature associated with the average duration of time spent by the set of vehicles 106 at the corresponding charging point, and the third feature associated with the destination information of set of vehicles 106 from the corresponding charging point may be retrieved from the one or more sources 104. At least one feature of the set of features 302A may be obtained from the probe data 204A associated with set of vehicles 106. In an embodiment, the apparatus 102 may be configured to retrieve, from the one or more sources 104, the set of features 302A including at least one of the first feature associated with the one or more points of interest within the second distance of the corresponding charging point of the set of charging points 110, the second feature associated with the average duration of time spent by the set of vehicles 106 at the corresponding charging point, and the third feature associated with the destination information of set of vehicles 106 from the corresponding charging point. The at least one feature of the set of features 302A may be obtained from the probe data 204A associated with the set of vehicles 106. The details about the set of features 302A are provided, for example, in FIG. 3A.

At 910, the one or more recommendations associated with the one or more charging points of set of charging points 110 may be generated based on the retrieved set of features 302A. In an embodiment, the apparatus 102 may be configured to generate the one or more recommendations associated with the one or more charging points of the set of charging points 110 based on the retrieved set of features 302A. The details about the generation of one or more recommendations are provided, for example, in FIG. 4, FIG. 5, and FIG. 6A.

At 912, the generated one or more recommendations may be rendered, via the user interface, as option for selection by the user 114. In an embodiment, the apparatus 102 may be configured to render, via the user interface 602, the generated one or more recommendations which may be provided as option for selection by the user 114. The details about providing one or more recommendations to the user 114 are provided, for example, in FIG. 6A.

Accordingly, blocks of the flowchart 700, 800, and 900 support combinations of means for performing the specified functions and combinations of operations for performing the specified functions. It will also be understood that one or more blocks of the flowchart 700, 800, and 900 can be implemented by special-purpose hardware-based computer systems which perform the specified functions, or combinations of special-purpose hardware and computer instructions.

Alternatively, the apparatus 102 may comprise means for performing each of the operations described above. In this regard, according to an example embodiment, examples of means for performing operations may comprise, for example, the processor 202 and/or a device or circuit for executing instructions or executing an algorithm for processing information as described above.

On implementing the flowcharts 500, 700, 800, and 900 disclosed herein, the end result generated by the apparatus 102 is a tangible navigation information to the recommended charging point based on the probe data.

In an embodiment, the computer program product comprising at least one non-transitory computer-readable storage medium having computer-executable program code portions stored therein, the computer-executable program code portions comprising program code instructions configured to determine a set of charging points within a first distance of the first vehicle based on the retrieved first location. The computer-executable program code portions further includes program code instructions configured to retrieve, from one or more sources, a set of features including at least one of a first feature associated with one or more points of interest within a second distance of a corresponding charging point of the set of charging points, a second feature associated with an average duration of time spent by the set of vehicles at the corresponding charging point, and a third feature associated with destination information of the set of vehicles based on the corresponding charging point. At least one feature of the set of features may be obtained from probe data associated with the set of vehicles. The computer-executable program code portions further includes program code instructions configured to generate one or more recommendations associated with one or more charging points of the set of charging points based on the retrieved set of features and provide the generated one or more recommendations as an option for selection by a user via a user interface.

In an embodiment, the computer-executable program code portions further include program code instructions configured to retrieve the first location associated with the first vehicle of the set of vehicles and determining the set of charging points within the first distance of the first vehicle based on the retrieved first location. The computer-executable program code portions further include program code instructions configured to retrieve, from one or more sources, a set of features including at least one of a first feature associated with one or more points of interest within a second distance of a corresponding charging point of the set of charging points, and a second feature associated with accessibility information for each charging point of the set of charging points. At least one feature of the set of features may be obtained from probe data associated with the set of vehicles. The computer-executable program code portions further include program code instructions configured to generate one or more recommendations associated with one or more charging points of the set of charging points based on the retrieved set of features. The computer-executable program code portions further include program code instructions configured to provide, via a user interface, the generated one or more recommendations as an option for selection by a user.

In an embodiment, the computer-executable program code portions further includes program code instructions configured to receive a first user input for providing the one or more recommendations associated with one or more charging points for charging a first vehicle of a set of vehicles. The computer-executable program code portions further includes program code instructions configured to retrieve a first location associated with a first vehicle of a set of vehicles. The operations may be further configured to determine a set of charging points within a first distance of the first vehicle based on the retrieved first location. The computer-executable program code portions further includes program code instructions configured to retrieve, from one or more sources, a set of features including at least one of a first feature associated with one or more points of interest within a second distance of a corresponding charging point of the set of charging points, a second feature associated with an average duration of time spent by the set of vehicles at the corresponding charging point, and a third feature associated with destination information of the set of vehicles based on the corresponding charging point. At least one feature of the set of features may be obtained from probe data associated with the set of vehicles. The computer-executable program code portions further includes program code instructions configured to generate one or more recommendations associated with one or more charging points of the set of charging points based on the retrieved set of features and provide the generated one or more recommendations as an option for selection by a user via a user interface.

Alternatively, the apparatus 102 may include means for performing each of the operations described above. In this regard, according to an example embodiment, examples of means for performing operations may include, for example, the processor 202 and/or a device or circuit for executing the computer program instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. An apparatus, comprising at least one processor and at least one non-transitory memory including computer program code instructions, the computer program code instructions configured to, when executed, cause the apparatus to:
retrieve a first location associated with a first vehicle of a set of vehicles;
determine a set of charging points within a first distance of the first vehicle based on the retrieved first location;
retrieve, from one or more sources, a set of features comprising at least one of: a first feature associated with one or more points of interest within a second distance of a corresponding charging point of the set of charging points, a second feature associated with an average duration of time spent by the set of vehicles at the corresponding charging point, and a third feature associated with destination information of the set of vehicles based on the corresponding charging point, wherein at least one feature of the set of features is obtained from probe data associated with the set of vehicles;
generate one or more recommendations associated with one or more charging points of the set of charging points based on the retrieved set of features; and
provide, via a user interface, the generated one or more recommendations as an option for selection by a user.

2. The apparatus of claim 1, wherein the computer program code instructions are configured to, when executed, cause the apparatus to:
apply a machine learning model on the retrieved set of features, wherein the machine learning model is a pre-trained model; and
generate the one or more recommendations associated with the one or more charging points of the set of charging points based on the application of the machine learning model on the retrieved set of features.

3. The apparatus of claim 1, wherein the computer program code instructions are configured to, when executed, cause the apparatus to:
receive a first user input associated with the selection of a first recommendation of the one or more recommendations, wherein the first recommendation is associated with a first charging point of the set of charging points; and
provide, via the user interface, navigation information associated with navigation from the first location to the first charging point based on the received first user input.

4. The apparatus of claim 1, wherein the computer program code instructions are configured to, when executed, cause the apparatus to:
retrieve, from the one or more sources, establishment information associated with each of the one or more points of interest, wherein the establishment information is indicative of a type of establishment associated with a corresponding point of interest of the one or more points of interest; and
generate the one or more recommendations associated with one or more charging points of the set of charging points based on the retrieved establishment information.

5. The apparatus of claim 4, wherein the computer program code instructions are configured to, when executed, cause the apparatus to:
update, using the one or more sources, the establishment information associated with each of the one or more points of interests within the second distance of the corresponding charging point;
determine a modification in the establishment information associated with at least one of the one or more points of interest based on the updated establishment information;
modify the one or more recommendations associated with the one or more charging points of the set of charging points based on the determined modification; and
provide, via the user interface, the modified one or more recommendations.

6. The apparatus of claim 1, wherein the computer program code instructions are configured to, when executed, cause the apparatus to:
determine, using the probe data, the average duration of time spent by the set of vehicles at first charging point of the set of charging points;
compare the determined average duration of time spent by the set of vehicles with a pre-determined threshold;
update charging point information associated with the first charging point of the set of charging points based on the comparison, wherein the one or more recommendations are generated based on the charging point information; and
store the updated charging point information in the one or more sources.

7. The apparatus of claim 6, wherein the computer program code instructions are configured to, when executed, cause the apparatus to:
calculate, using the probe data, a duration of time spent by each vehicle of the set of vehicles based on arrival time information and departure time information of the set of vehicles at the corresponding charging point of the set of charging points; and
determine the average duration of time spent by the set of vehicles associated with the corresponding charging point based on the calculated duration of time spent by each vehicle of the set of vehicles.

8. The apparatus of claim 1, wherein the computer program code instructions are configured to, when executed, cause the apparatus to:
retrieve, using one or more sources, a fourth feature indicative of parking information associated with each charging point of the set of charging points;
retrieve, using one or more sources, a fifth feature associated with a functional class of a road segment associated with each charging point of the set of charging points;
update charging point information associated with each charging point of the set of charging points based on at least one of: the fourth feature or the fifth feature, wherein the one or more recommendations are generated based on the charging point information; and
store the updated charging point information in the one or more sources.

9. The apparatus of claim 1, wherein the computer program code instructions are configured to, when executed, cause the apparatus to:
obtain, from an electronic device associated with the user, second location information indicative of a location of the user of the first vehicle at a charging point of the set of charging points, wherein the second location information is obtained for a first time period;
determine mobility information associated with a mobility of the user during the first time period based on the obtained second location; and
update charging point information associated with the corresponding charging point based on the determined mobility information, wherein the one or more recommendations are generated based on the charging point information; and
store the updated charging point information in the one or more sources.

10. The apparatus of claim 1, wherein the computer program code instructions are configured to, when executed, cause the apparatus to:
determine, using one or more sources, a sixth feature associated with accessibility information for each charging point of the set of charging points;
update charging point information associated with the corresponding charging point of the set of charging points based on the determined sixth feature, wherein the one or more recommendations are generated based on the charging point information; and
store the updated charging point information in the one or more sources.

11. The apparatus of claim 10, wherein the computer program code instructions are configured to, when executed, cause the apparatus to:
retrieve a second location associated with the first vehicle of the set of vehicles;
determine the set of charging points within the first distance of the first vehicle based on the retrieved second location;
retrieve, from the one or more sources, the set of features associated with each charging point of the set of charging points;
generate a first recommendation associated with a first charging point of the set of charging points based on the retrieved set of features and the updated charging point information associated with each charging point of the one or more charging points; and
provide, via the user interface, the generated first recommendation.

12. A method comprising:
retrieving a first location associated with a first vehicle of a set of vehicles;
determining a set of charging points within a first distance of the first vehicle based on the retrieved first location;
retrieving, from one or more sources, a set of features comprising at least one of:
a first feature associated with one or more points of interest within a second distance of a corresponding charging point of the set of charging points, and a second feature associated with accessibility information for each charging point of the set of charging points, wherein at least one feature of the set of features is obtained from probe data associated with the set of vehicles;
generating one or more recommendations associated with one or more charging points of the set of charging points based on the retrieved set of features; and
providing, via a user interface, the generated one or more recommendations as an option for selection by a user.

13. The method of claim 12, further comprising:
applying a machine learning model on the retrieved set of features, wherein the machine learning model is a pre-trained model; and
generating the one or more recommendations associated with the one or more charging points of the set of charging points based on the application of the machine learning model on the retrieved set of features.

14. The method of claim 12, further comprising:
receiving a first user input associated with the selection of a first recommendation of the one or more recommendations, wherein the first recommendation is associated with a first charging point of the set of charging points; and
rendering, on the user interface, navigation information associated with navigation from the first location to the first charging point based on the received first user input.

15. The method of claim 12, further comprising:
retrieving, from the one or more sources, establishment information associated with each of the one or more points of interest, wherein the establishment information is indicative of a type of establishment associated with a corresponding point of interest of the one or more points of interest; and
generating the one or more recommendations associated with one or more charging points of the set of charging points based on the retrieved establishment information.

16. The method of claim 15, further comprising:
updating, using the one or more sources, the establishment information associated with each of the one or more points of interests within the second distance of the corresponding charging point;
determining a modification in the establishment information associated with at least one of the one or more points of interest based on the updated establishment information;
modifying the one or more recommendations associated with the one or more charging points of the set of charging points based on the determined modification; and
providing, via the user interface, the modified one or more recommendations.

17. The method of claim 12, further comprising:
retrieving, using one or more sources, a third feature associated with an average duration of time spent by the set of vehicles at the corresponding charging point;
updating charging point information associated with the corresponding charging point based on the retrieved third feature, wherein the one or more recommendations are generated based on the charging point information; and
storing the updated charging point information in the one or more sources.

18. The method of claim 12, further comprising:
obtaining, from an electronic device associated with the user, second location information indicative of a location of the user of the first vehicle at a charging point of the set of charging points, wherein the second location information is obtained for a first time period;
determining mobility information associated with a mobility of the user during the first time period based on the obtained second location; and
updating charging point information associated with the corresponding charging point based on the determined mobility information, wherein the one or more recommendations are generated based on the charging point information; and
storing the updated charging point information in the one or more sources.

19. A computer program product comprising at least one non-transitory computer-readable storage medium having computer-executable program code portions stored therein, the computer-executable program code portions comprising program code instructions configured to:
receive a first user input for generating one or more recommendations associated with one or more charging points for charging a first vehicle of a set of vehicles;
retrieve a first location associated with the first vehicle of the set of vehicles based on the received first user input;
determine a set of charging points within a first distance of the first vehicle based on the retrieved first location;
retrieve, from one or more sources, a set of features comprising at least one of: a first feature associated with one or more points of interest within a second distance of a corresponding charging point of the set of charging points, a second feature associated with an average duration of time spent by the set of vehicles at the corresponding charging point, or a third feature associated with destination information of the set of vehicles from the corresponding charging point, wherein at least one feature of the set of features is obtained from probe data associated with the set of vehicles;
generate the one or more recommendations associated with one or more charging points of the set of charging points based on the retrieved set of features; and
render, via a user interface, the generated one or more recommendations as an option for selection by a user.

20. The computer program product of claim 19, wherein the computer-executable program code portions further comprises program code instructions configured to:
receive, from the user, a second input associated with the selection of a first recommendation of the one or more recommendations, wherein the first recommendation is associated with a first charging point of the set of charging points; and
provide, via the user interface, navigation information associated with navigation from the first location to the first charging point based on the received second user input.
